(19) United States
(12) Patent Application Publication
(10) Pub. No.: US 2024/0256857 A1
(43) Pub. Date: Aug. 1, 2024

(54) SYSTEMS AND METHODS FOR TRAINING AND LEVERAGING A MULTI-HEADED MACHINE LEARNING MODEL FOR PREDICTIVE ACTIONS IN A COMPLEX PREDICTION DOMAIN

(71) Applicant: UnitedHealth Group Incorporated, Minnetonka, MN (US)

(72) Inventors: Carlos W. MORATO, Sammamish, WA (US); Yan WANG, Shoreview, MN (US); Mamatha JULURU, Tempe, AZ (US)

(21) Appl. No.: 18/309,088

(22) Filed: Apr. 28, 2023

Related U.S. Application Data
(60) Provisional application No. 63/482,612, filed on Feb. 1, 2023.

(51) Int. Cl. G06N 3/08

(52) U.S. Cl. CPC G06N 3/08

(57) ABSTRACT

Various embodiments of the present disclosure provide machine learning techniques for transforming third-party coding sets to universal canonical representations. The techniques may include receiving a plurality of training datasets corresponding to a plurality of predictive categories and generating a plurality of teacher models respectively corresponding to the plurality of predictive categories based on the plurality of training datasets. The techniques include generating a multi-headed composite model based on a plurality of trained parameters for each of the plurality of teacher models. The multi-headed composite model includes a plurality of model heads that respectively correspond to the plurality of teacher models and the plurality of predictive categories. The multi-headed composite model is leveraged to generate an output embedding for a text input of any predictive category. Each text input is processed by selecting a particular head of the multi-headed composite model that corresponds to the predictive category of the text input.

### CROSS-REFERENCE TO RELATED APPLICATIONS

This application claims the benefit of U.S. Provisional Application No. 63/482,612, entitled “CHIMERANET FOR UNIVERSAL ONTOLOGY ALIGNMENT FRAMEWORK,” and filed Feb. 1, 2023, the entire contents of which are hereby incorporated by reference.

### BACKGROUND

Various embodiments of the present disclosure address technical challenges related to data aggregation and transformation across large scale, incompatible datasets given limitations of existing computer data processing and interpretation techniques. Existing processes for aggregating data across a plurality of incompatible code sets rely on manual mapping processes by trained experts that attempt to match third-party specific codes to internal concepts. Alternatives leverage machine learning techniques to replace manual mapping processes. However, traditional machine learning techniques include a single processing pipeline for a wide variety of third-party codes. In doing so, such techniques often suffer from biased or unbalanced training data and are unable to efficiently handle dynamic third-party code sets in which new codes are often added. For example, traditional techniques for mapping third-party codes to third party-agnostic concepts may exhibit poor performance due to the use of only a single attention head for all categories of third-party codes. Moreover, such techniques require high training times and costs for sufficiently training a model to handle all possible mapping scenarios. Once trained, such models may be large or have heavy-weighted attention heads and therefore suffer from large performance costs, high latency, and low availability due to hardware constraints. Various embodiments of the present disclosure make important contributions to various existing computer data processing and interpretation techniques by addressing each of these technical challenges.

### BRIEF SUMMARY

Various embodiments of the present disclosure disclose a multi-headed machine learning model architecture, machine learning training approaches for training the multi-headed model, and techniques for using the model to generate a third-party agnostic representation of a text input. The multi-headed machine learning architecture may include a multi-headed composite model with a model body, a plurality of model heads, and a gate function to route a text input through one or more of the plurality of heads. In this way, the multi-headed composite model allows for the use of multiple processing pipelines that are capable of efficiently handling a wide variety of third-party codes. The machine learning training approaches leverage transfer training and knowledge distillation techniques to train multiple light-weight components of the multi-headed composite model based on heavy-weighted teacher models. By doing so, the machine learning training approaches may reduce training times and costs for training large, complex, machine learning models for a complex prediction domain. The resulting multi-headed composite model may be leveraged to identify third party agnostic concepts from a plurality of different codes in an efficient manner by tailoring the processing pipeline for each code to the specifics of the code. This, in turn, allows for the efficient interpretation of codes across a plurality of different, traditionally incompatible, third-party datasets and, ultimately, enables the generation of more granular, accurate, and refined, predictive insights.

In some embodiments, a computer-implemented method includes receiving, by one or more processors, a plurality of training datasets corresponding to a plurality of predictive categories; generating, by the one or more processors, a plurality of teacher models corresponding to the plurality of predictive categories based on the plurality of training datasets, wherein each teacher model is trained by optimizing a triplet loss for a particular training dataset of the plurality of training datasets; and generating, by the one or more processors, a multi-headed composite model based on a respective plurality of trained parameters for each of the plurality of teacher models, wherein the multi-headed composite model comprises a plurality of model heads that correspond to the plurality of teacher models.

In some embodiments, a computing apparatus includes a memory and one or more processors communicatively coupled to the memory. The one or more processors are configured to receive a plurality of training datasets corresponding to a plurality of predictive categories; generate a plurality of teacher models corresponding to the plurality of predictive categories based on the plurality of training datasets, wherein each teacher model is trained by optimizing a triplet loss for a particular training dataset of the plurality of training datasets; and generate a multi-headed composite model based on a plurality of trained parameters for each of the plurality of teacher models, wherein the multi-headed composite model comprises a plurality of model heads that correspond to the plurality of teacher models.

In some embodiments, one or more non-transitory computer-readable storage media include instructions that, when executed by one or more processors, cause the one or more processors to: receive a plurality of training datasets corresponding to a plurality of predictive categories; generate a plurality of teacher models corresponding to the plurality of predictive categories based on the plurality of training datasets, wherein each teacher model is trained by optimizing a triplet loss for a particular training dataset of the plurality of training datasets; and generate a multi-headed composite model based on a plurality of trained parameters for each of the plurality of teacher models, wherein the multi-headed composite model comprises a plurality of model heads that correspond to the plurality of teacher models.

In some embodiments, computer-implemented method includes receiving, by one or more processors, a text input and contextual data indicative of a predictive category for the text input; generating, by the one or more processors and using a multi-headed composite model, an output embedding for the text input based on the predictive category, wherein the multi-headed composite model comprises a model body, a plurality of model heads, and a gate function, the text input is processed with at least one model head of the plurality of model heads, and the gate function is configured to select the at least one model head based on the predictive category for the text input; and providing, by the one or more processors, a predictive label for the text input based on the output embedding.

In some embodiments, a computing apparatus includes a memory and one or more processors communicatively coupled to the memory. The one or more processors are configured to receive a text input and contextual data indicative of a predictive category for the text input; generate, using a multi-headed composite model, an output embedding for the text input based on the predictive category, wherein the multi-headed composite model comprises a model body, a plurality of model heads, and a gate function, the text input is processed with at least one model head of the plurality of model heads, and the gate function is configured to select the at least one model head based on the predictive category for the text input; and provide a predictive label for the text input based on the output embedding.

In some embodiments, one or more non-transitory computer-readable storage media include instructions that, when executed by one or more processors, cause the one or more processors to receive a text input and contextual data indicative of a predictive category for the text input; generate, using a multi-headed composite model, an output embedding for the text input based on the predictive category, wherein the multi-headed composite model comprises a model body, a plurality of model heads, and a gate function, the text input is processed with at least one model head of the plurality of model heads, and the gate function is configured to select the at least one model head based on the predictive category for the text input; and provide a predictive label for the text input based on the output embedding.

### BRIEF DESCRIPTION OF THE DRAWINGS

FIG. 1 illustrates an example computing system in accordance with one or more embodiments of the present disclosure.

FIG. 2 is a schematic diagram showing a system computing architecture in accordance with some embodiments discussed herein.

FIG. 3 provides a dataflow diagram of a multistage training technique for generating a multi-headed composite model in accordance with some embodiments discussed herein.

FIG. 4A provides an operational example of mapped text sequences in accordance with some embodiments discussed herein.

FIG. 4B provides an operational example of mapped text sequences within a particular predictive category in accordance with some embodiments discussed herein.

FIG. 5 provides an operational example of a teacher model in accordance with some embodiments discussed herein.

FIG. 6 provides a dataflow diagram of a teacher training phase of a model training process in accordance with some embodiments discussed herein.

FIG. 7 provides a dataflow diagram of a composite model training phase of a model training process in accordance with some embodiments discussed herein.

FIG. 8 provides a dataflow diagram of a refinement training phase of a model training process in accordance with some embodiments discussed herein.

FIG. 9 provides a dataflow diagram of an operation of a multi-headed composite model in accordance with some embodiments discussed herein.

FIG. 10 is a flowchart showing an example of a process for generating a multi-headed composite model in accordance with some embodiments discussed herein.

FIG. 11 is a flowchart showing an example of a process for generating a predictive label for a text input in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that the present disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

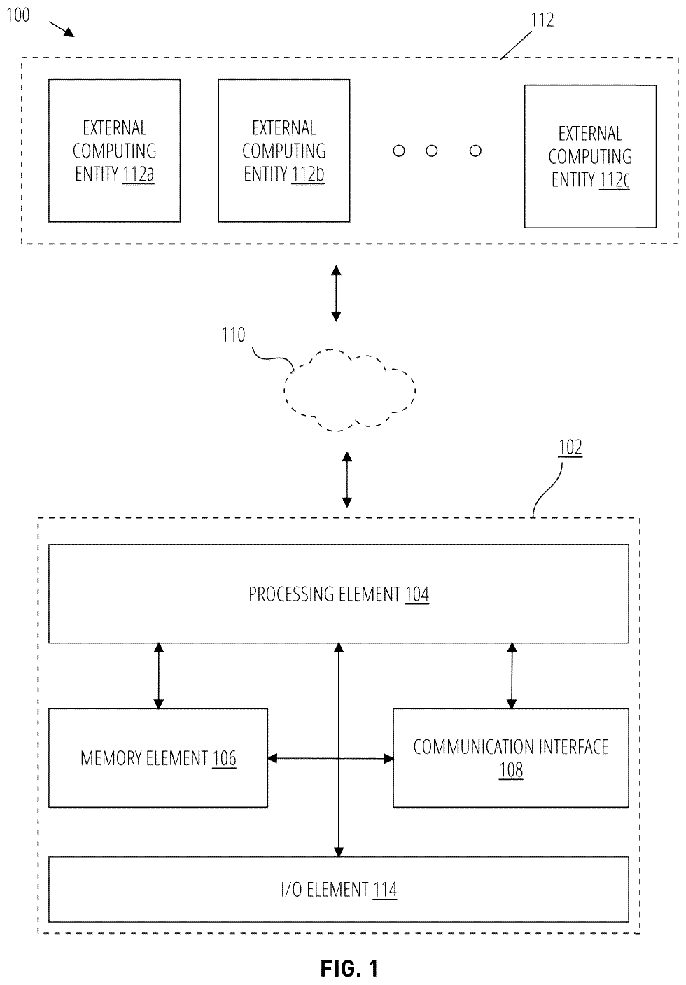

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., data processing techniques, predictive classification techniques, data transformation techniques, and/or the like) described herein.

The external computing entities 112a-c, for example, may include and/or be associated with one or more third parties that may be configured to receive, store, manage, and/or facilitate third-party datasets that include text sequences and/or codes from one or more incompatible third-party coding sets. The external computing entities 112a-c may provide the third-party data to the predictive computing entity 102 which may transform the third-party data into one or more third-party agnostic formats. By way of example, the predictive computing entity 102 may include a data processing system that is configured to leverage different text sequences corresponding to a variety of incompatible third-party coding sets to transform otherwise uninterpretable third-party codes to canonical representations of the third-party codes. In some examples, this may enable the aggregation of data from across the external computing entities 112a-c. The external computing entities 112a-c, for example, may be associated with one or more data repositories, cloud platforms, compute nodes, organizations, and/or the like, that may be individually and/or collectively leveraged by the predictive computing entity 102 to obtain and aggregate traditionally incompatible sets of data for a prediction domain.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

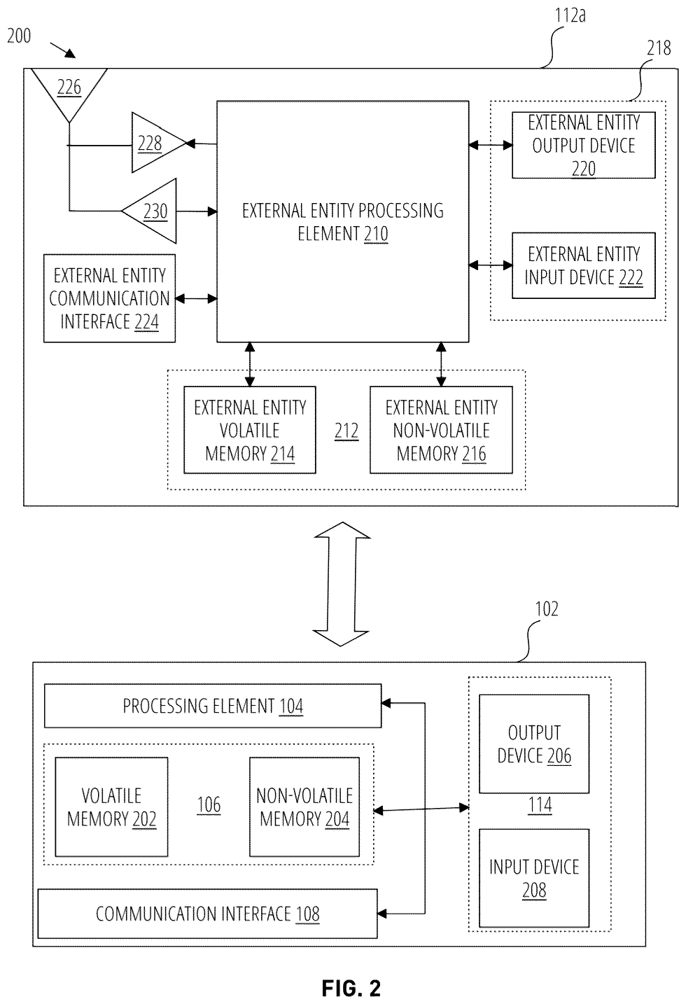

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically crasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The predictive computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “multi-headed composite model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The multi-headed composite model may include a multi-headed machine learning model configured, trained, and/or the like to generate an output embedding for a text input that may be leveraged for a classification, predictive, and/or one or more other computer text interpretation tasks. The multi-headed composite model may include one or more of any type of machine learning model including one or more supervised, unsupervised, semi-supervised, reinforcement learning models, and/or the like. In some examples, the multi-headed composite model may include multiple models configured to perform one or more different stages of an embedding and/or classification process.

In some embodiments, the multi-headed composite model includes a neural network with a plurality of attention layers. For example, the multi-headed composite model may include a model body and/or a plurality of model heads that may each form a portion of the multi-headed composite model. In some examples, the model body may include a first plurality of attention blocks, m, that are common to all inputs to the multi-headed composite model. In some examples, each of the plurality of model heads may include a second plurality of attention blocks, h, that are specific to a particular type of input.

In some embodiments, the multi-headed composite model comprises a neural network architecture that is trained using one or more machine learning techniques. In some examples, one or more portions of the neural network architecture may be individually and/or jointly trained using one or more machine learning training techniques. For example, the multi-headed composite model may be trained over a multistage training technique. During a first stage of the multistage training technique, the model body and/or each of the model heads may be individually trained using knowledge transfer techniques, such as teacher-student transfer learning. During a second stage of the multistage training technique, the model body and/or each of the model heads may be jointly trained using one or more knowledge distillation techniques, such as teacher-student knowledge distillation.

In some embodiments, the multi-headed composite model includes a gate function that is configured to select the at least one model head of the multi-headed composite model based on the predictive category. By doing so, the gate function may route different inputs of the multi-headed composite model through different branches of the model, each formed by the model body and a respective model head. The gate function, for example, may include a trained function that is configured to process an input data object to select a particular model head of the multi-headed composite model for the input data object. For each input data object, the gate function may be trained to dynamically choose a particular model head to drive the choice of a particular model head for processing the input data object.

In some embodiments, the multi-headed composite model may include a plurality of model heads that are tailored to a particular category of input data object. For example, the number and/or type of model heads may be based on a prediction domain. In some examples, each model head may correspond to an ontology category for a prediction domain. As one example, for a clinical prediction domain, each model head may correspond to a first-party ontology category for a medical coding set. By way of example, the multi-headed composite model may be configured to generate a predictive label for a text input from one of a plurality of third-party sources in order to map inconsistent third-party coding formats to a single, consistent set of concepts.

In some embodiments, the first-party label is one of a plurality first-party labels from a canonical coding set defined, maintained, and/or otherwise used by the first party to provide a standardized representation of a plurality of inconsistent third-party coding sets. In some examples, the plurality of first-party labels may be grouped into a plurality of predictive categories. The multi-headed composite model may include a particular model head for each of the plurality of predictive categories. By way of example, in a clinical context, the plurality of predictive categories may include fifteen categories based on the semantic types of a plurality of first-party labels. In such a case, the multi-headed composite model may include fifteen model heads, one specifically tailored to each of the fifteen categories.

In some embodiments, the term “model body” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The model body may include a first portion of the multi-headed composite model that is configured, trained, and/or the like to generate an intermediate output for an input data object. The model body may include one or more of any type of machine learning model including one or more supervised, unsupervised, semi-supervised, reinforcement learning models, and/or the like. In some examples, the model body may include a first plurality of attention blocks, m, that are common to all inputs to the multi-headed composite model.

In some embodiments, the term “model head” refers to a data entity refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A model head may include a second portion of the multi-headed composite model that is configured, trained, and/or the like to generate an output embedding for an input data object based on an intermediate output of the model body. The model head may include one or more of any type of machine learning model including one or more supervised, unsupervised, semi-supervised, reinforcement learning models, and/or the like. In some examples, the model head may include a second plurality of attention blocks, h, that are specific to a particular type of input.

In some embodiments, the term “first party” refers to an entity that is associated with a canonical dataset. The first party may be configured to generate, maintain, store, convert, and/or the like, data that is defined by a first-party coding set. The first-party coding set may include a canonical coding set for standardizing a plurality of at least partially incompatible third-party coding sets leveraged by a plurality of related third parties. In some examples, the first party may be configured to generate first-party data from third-party data coded in accordance with one or more of the third-party coding sets. For example, the first party may leverage the multi-headed composite model to transform a third-party dataset to a canonical dataset that represents a standardized version of the third-party dataset. The first party may be based on the prediction domain. In some examples, the first party may include a clinical provider that is configured to aggregate data from a plurality of third-party clinical providers that leverage a plurality of incompatible, medical external coding sets.

In some embodiments, the term “third party” refers to an entity that is associated with a third-party coding set. The third party may be configured to generate, maintain, store, and/or the like, data that is defined by a third-party coding set. The third-party coding set may be at least partially incompatible with a plurality of other third-party coding sets leveraged by a plurality of related third parties.

The third party may be based on the prediction domain. In some examples, the third party may include a clinical provider that is configured to generate, maintain, store, and/or the like, medical data, such as medical claims, and/or the like, that is coded according to a medical, external, coding set. In some examples, the external coding set may be unique to the third party. By way of example, the third party may be one of a variety of medical sources, such as government and/or private entities that use medical coding sets, such as International Classification of Disease, Tenth Revision (ICD10), Logical Observation Identifiers Names and Codes (LOINC), Systemized Nomenclature of Medicine—Clinical Terms (SNOMED CT), and/or the like.

In some embodiments, the term “canonical dataset” refers to a data entity that describes a first-party dataset that includes standardized data from across a plurality of third parties. The canonical dataset may include a plurality of canonical data objects. In some examples, the canonical dataset may include third-party data that is transformed from a third-party coding set to a canonical coding set. For example, each canonical data object may include a first-party label that describes a canonical code from a canonical coding set.

In some embodiments, the term “first-party label” refers to a data entity that describes a canonical label for a data object of a canonical dataset. In some embodiments, the first-party label is a data entity that describes a canonical label for a data object of a canonical dataset. The first-party label, for example, may describe a canonical code from a canonical coding set. For instance, the first-party label may include a text description for the canonical code. The text description may include a predefined, ontology agnostic description for the canonical code.

The first-party label may be based on the prediction domain. In some examples, in a clinical domain, a first-party label may include a standardized label for a universal medial ontology that is generalizable to each of a plurality of incompatible medical coding sets.

In some embodiments, the term “predictive category” refers to a data entity that describes a group of first-party labels. For example, a first-party label may be one of a plurality of first-party labels defined by a canonical coding set. The plurality of first-party labels may be separated into different predictive categories based on one or more label attributes, such as a semantic type, and/or the like. For instance, a predictive category may include a subset of the plurality of first-party labels that are associated with a respective semantic type. The predictive category may be based on the prediction domain. In some examples, in a clinical domain, the predictive category may include an ontology category of a universal ontology. By way of example, the predictive category may include one of fifteen groups of internal coding sets. In some examples, each of the fifteen groups of internal coding sets may be mapped to thirty-seven different, inconsistent third-party coding sets.

In some embodiments, the term “composite dataset” refers to a data entity that describes training data for the multi-headed composite model. The composite dataset may include a plurality of training data objects. Each training data object may include a mapped text sequence. A mapped text sequence, for example, may include a text sequence and a training label corresponding to the text sequence. For example, the composite dataset may include a plurality of training data objects that respectively include a plurality of different text sequences from one or more different third parties. Each training data object may include (i) a text sequence that is descriptive of a code from a third-party coding set of a respective third party and (ii) a corresponding first-party label that is descriptive of a canonical code of a universal ontology.

The composite dataset may be based on the prediction domain. In some examples, in a clinical domain, the composite dataset may include a plurality of mapped text sequences from a plurality of different medical resources. Each mapped text sequence may include (i) a text sequence that is descriptive of a medical code unique to a medical resource and (ii) a corresponding first-party label that is descriptive of a canonical code of a universal ontology.

In some embodiments, the term “training dataset” refers to a data entity that describes a portion of the composite dataset. A training dataset may include a subset of training data objects from the composite dataset that correspond to a particular predictive category. For example, a training dataset may include a subset of mapped text sequences that correspond to a particular predictive category. The subset of mapped text sequences, for example, may each include a first-party label that corresponds to the particular predictive category. In some examples, the composite dataset may be divided into a plurality of training datasets. Each of the plurality of training dataset may correspond to one of a plurality of predictive categories for the prediction domain.

Each training dataset may be based on the prediction domain. In some examples, in a clinical domain, the training dataset may include a portion of training data that corresponds to an ontology category of a universal ontology. In the event that the universal ontology has fifteen ontology categories, the composite dataset may be divided into fifteen training datasets, one for each of the fifteen ontology categories.

In some embodiments, the term “mapped text sequence” refers to a data entity that describes a labeled input for training a machine learning model. The mapped text sequence may include a text sequence and/or a corresponding label for the text sequence. For example, the text sequence may include a first sequence of characters, numbers, words, symbols, and/or the like, that describe a particular third-party code from a third-party coding set. The label may include a second sequence of characters, numbers, words, symbols, and/or the like, that describe a canonical code from a canonical coding set. By way of example, the mapped text sequence may include a third-party text sequence and a corresponding first-party label.

In some embodiments, the term “training label” refers to a data entity that describes a first-party label for a mapped text sequence. The training label may include a first-party label that corresponds to a particular text sequence of a mapped text sequence.

In some embodiments, the term “teacher model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The teacher model may include a machine learning model that is configured, trained, and/or the like to generate an output embedding for a text input that may be leveraged for a classification, predictive, and/or one or more other computing tasks. The teacher model may include one or more of any type of machine learning model including one or more supervised, unsupervised, semi-supervised, reinforcement learning models, and/or the like.

In some embodiments, the teacher model includes a neural network that is trained to generate an output embedding for a text sequence within a particular predictive category. The teacher model, for example, may include a deep neural network with a set of attention blocks used to transform a text sequence into an output embedding. The attention blocks, for example, may include a self-attention layer, a first normalization layer, a fully connected feed forward network, a second normalization layer, and/or the like.

The teacher model may be trained using one or more machine learning training techniques. By way of example, the teacher model may be trained using one or more supervised machine learning techniques using a training dataset for a particular predictive category. The one or more supervised machine learning training techniques may include any of a plurality of different machine learning techniques, such as triplet loss training, and/or the like. In some examples, the teacher model may be specially configured for one of a plurality of predictive categories of a prediction domain. For example, a teacher model may be trained for each predictive category of the prediction domain.

In some embodiments, the term “triplet loss” refers to a data entity that describes a model loss for training a teacher model. The triplet loss may be generated using a triplet loss function that is configured to compare a plurality of text sequences and/or training labels. For example, the triplet loss may be generated based on a comparison between an anchor text sequence to a positive and negative label. By way of example, the triplet loss may be based on (i) a first distance between the anchor text sequence and a positive label and (ii) a second distance between the anchor text sequence and the negative label. In some examples, the distances may be based on a distance between one or more text embeddings for the anchor text sequence, the positive label, and/or the negative label. In some examples, a teacher model may be trained by minimizing the first distance, while maximizing the second distance.

In some embodiments, the term “anchor text sequence” refers to a data entity that describes a baseline input for training a machine learning model. The anchor text sequence may include a text sequence from a mapped text sequence.

In some embodiments, the term “anchor embedding” refers to a data entity that describes an embedding for the anchor text sequence. The anchor embedding, for example, may include a text embedding for the anchor text sequence. For example, the anchor embedding may include a real-valued vector that encodes one or more attributes for the anchor text sequence. The anchor embedding may be generated for the anchor text sequence using a teacher model and/or an encoder with an architecture similar to the teacher model.

In some embodiments, the term “positive training label” refers to a data entity that describes a positive input for training a machine learning model. The positive training label may include a training label from the mapped text sequence that includes the anchor text sequence.

In some embodiments, the term “positive embedding” refers to a data entity that describes an embedding for the positive training label. The positive embedding, for example, may include a text embedding for the positive training label. For example, the positive embedding may include a real-valued vector that encodes one or more attributes for the positive training label. The positive embedding may be generated for the positive training label using a teacher model and/or an encoder with an architecture similar to the teacher model.

In some embodiments, the term “negative training label” refers to a data entity that describes a negative input for training the machine learning model. The negative training label may include a training label that is not included in the mapped text sequence that includes the anchor text sequence.

In some embodiments, the term “negative embedding” refers to a data entity that describes an embedding for the negative training label. The negative embedding, for example, may include a text embedding for the negative training label. For example, the negative embedding may include a real-valued vector that encodes one or more attributes for the negative training label. The negative embedding may be generated for the negative training label using a teacher model and/or an encoder with an architecture similar to the teacher model.

In some embodiments, the term “composite loss function” refers to a data entity that describes parameters, hyper-parameters, and/or defined operations of a model training and/or evaluation techniques. The composite loss function, for example, may include a training technique configured to generate a model loss for the multi-headed composite model. The composite loss function may include a teacher-student knowledge distillation process in which individual intermediate outputs of each of a plurality of teacher models is distilled into a respective model head of the multi-headed composite model. To do so, the composite loss function may be configured to generate a model loss for the composite model based on one or more outputs of the plurality of teacher models. The composite loss function, for example, may include a Kullback-Leibler divergence loss, a Mean-Square Error loss, a distance-based loss, and/or the like, and/or the model loss may include an Kullback-Leibler Divergence Loss, a Mean-Square Error loss, a distance-based loss, and/or the like.

In this manner, knowledge distillation may be used to capture the knowledge from a large model (e.g., a teacher model) or set of models (e.g., a plurality of teacher models) to a single smaller model (e.g., a model head) with comparable performance that can be practically deployed under real-world constraints. To do so, intermediate outputs of larger, teacher models, may be used to train a smaller, model head. In some examples, the model heads and model body of the multi-headed composite model may be jointly trained to reduce, minimize, and/or maximize the model loss. By way of example, the multi-headed composite model may be trained to minimize the model loss.

In some embodiments, the term “input data object” refers to a data entity that describes an input to the multi-headed composite model. In some examples, the input data object may include a text input and/or data indicative of a predictive category for the text input. By way of example, the text input may include a text chunk that is associated with any of a plurality of third parties and/or third-party coding sets thereof. By way of example, in a clinical prediction domain, a text input may include a text description (e.g., “Unspecified injury of gallbladder, initial encounter,” etc.) that describes a third-party code from a third-party dataset. The predictive category may include a predictive category that corresponds to the text input.

In some embodiments, the term “output embedding” refers to a data entity that describes an output of the multi-headed composite model. The output embedding may include a vectorized representation of the text input (e.g. [0.13, 0.28, 0.97, . . . ], etc.). In some examples, the output embedding has a 768 dimensionality. The output embedding may include a contextual representation with semantics that allow ontology mapping (different ways to represent/write the chunks that will be mapped to the core concepts or meanings). This vectorized representation can be used as input for many other downstream tasks including ontology mapping as described herein.

In some embodiments, the term “predictive label” refers to a data entity that describes a prediction for a text input to the multi-headed composite model. The predictive label, for example, may identify a first-party label from a canonical coding set that corresponds to the text input. In some examples, the first-party label may be based on a distance between the output embedding and/or one or more first-party embeddings corresponding to the plurality of first-party labels of the first party.

### IV. Overview, Technical Improvements, and Technical Advantages

Some embodiments of the present disclosure present machine learning techniques for training machine learning models and leveraging machine learning models to improve upon traditional prediction techniques in complex prediction domains. Complex prediction domains, such as clinical prediction domains, require communications between multiple, disparate, third parties that each may operate with inconsistent data formats, such as inconsistent medical coding sets. Data incompatibilities across third-party datasets prevent the interpretation of data from multiple third parties which leads to inaccuracies and miscommunications between parties in a complex prediction domain. Traditionally, this technical problem had been addressed by using machine learning models to transform third-party coded data to a universally interpretable data format. However, traditional models rely on a single attention head which provides limited predictive performance, requires extensive amounts of training time and costs, and suffer from constraints, such as cost, latency, and availability of hardware that are associated with models or sets of models that are large and/or have heavy-weighted attention heads. Some embodiments of the present disclosure address each of these technical problems by enabling a (i) the creating of a multi-headed composite model, (ii) training techniques for training the multi-headed composite model, and (iii) techniques for using the multi-headed composite model to generate predictive outputs for a complex prediction domain.

Is some embodiments, a multi-headed composite model of the present disclosure includes multiple components that are specially configured to handle various inputs of different predictive categories of a complex prediction domain. The model may include a model architecture with a model body common to all inputs and a plurality of model heads, each specifically trained for a particular category of input. In addition, the model may include a gate function that drives the choice of a particular head for each input to the model. For a downstream task that requires outputs from multiple heads, the trained gate function may dynamically choose which branch of the model to use. In this manner, a multi-headed composite model may facilitate a plurality of data processing branches that may each be tailored to a specific input. In this way, the model architecture may improve upon the predictive performance of traditional machine learning models, while reducing processing time and resources needed for generating a predictive insight. Ultimately, this enables the efficient generation of predictive insights across a plurality of different categories within a complex prediction domain. When applied in a clinical prediction domain, the multi-headed composite model may accurately and efficiently transform data recorded with a wide variety of robust, dynamically changing coding sets to form a universal ontology of information aggregated across a plurality of disparate, incompatible, third-party datasets.

In some embodiments of the present disclosure, a machine learning model is trained using a multistage training technique that leverages teacher training and knowledge distillation techniques to reduce the size and training time of a machine learning model without degrading model performance. For instance, the multistage training technique may include four phases, including: (i) a data collection phase during which a robust dataset is divided into multiple training datasets for individually training portions of the machine learning model, (ii) a teacher training phase during which multiple teacher models are trained using the multiple training datasets, (iii) a model training phase during which the machine learning model is generated based on the trained parameters of the teacher models using transfer knowledge training techniques, and (iv) a model refinement phase during which the machine learning model is refined based on the outputs of the teacher models using knowledges distillation techniques. The multistage training technique may reduce training times and costs for training large, complex, machine learning models for a complex prediction domain. This, in turn, improves upon traditional machine learning training techniques by enabling the efficient generation and continual adaptation of machine learning models for complex prediction domains which, ultimately, results in dynamic machine learning models that may adapt to changes in constantly changing environments.

Example inventive and technologically advantageous embodiments of the present disclosure include (i) a machine learning model architecture specially configured for a handling multiple prediction categories of data in a complex prediction domain, (ii) training techniques, including triplet loss functions, for efficiently training machine learning models, (iii) predictive techniques for using components of a machine learning model, such as a model body, model head, and gate function, to generate predictive outputs for a complex prediction domain.

### V. Example System Operations

As indicated, various embodiments of the present disclosure make important technical contributions to machine learning technology. In particular, systems and methods are disclosed herein that implement machine learning training techniques and machine learning models for transforming inputs of a variety of prediction categories to canonical representations of the inputs. Unlike traditional data transformation techniques, the machine learning techniques of the present disclosure leverage a multi-headed machine learning model and training techniques for the multi-headed machine learning model to form multiple different data processing branches from one central model that is adaptable to changes within a prediction domain.

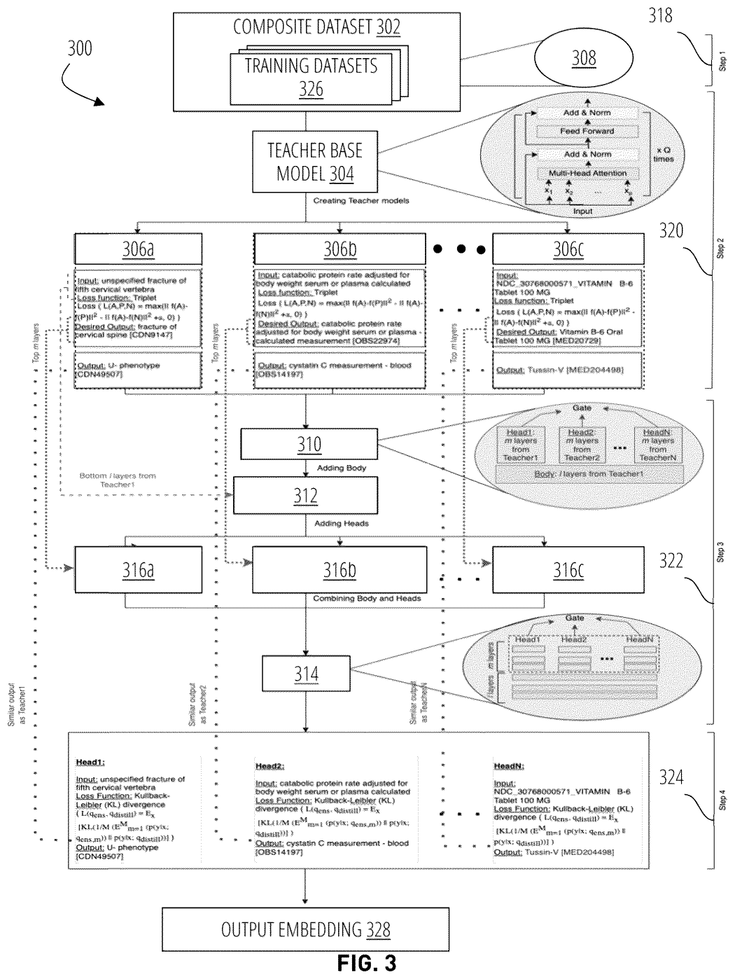

FIG. 3 provides a dataflow diagram 300 of a multistage training technique for generating a multi-headed composite model in accordance with some embodiments discussed herein. The multistage training technique may include one or more steps, phases, and/or the like, for training a multi-headed composite model 314. The multi-headed composite model 314, for example, may be trained over a first, data collection phase 318, a second, teacher training phase 320, a third, composite model training phase 322, and/or a fourth, model refinement phase 324.

In some embodiments, during the data collection phase 318, a plurality of training datasets 326 is received that corresponds to a plurality of predictive categories. The plurality of training datasets 326 may include a training dataset for each of a plurality of predictive categories of a prediction domain. For example, the plurality of predictive categories may define one or more groups of related data objects from a composite dataset 302 for the prediction domain.

In some embodiments, the composite dataset 302 is a data entity that describes training data for the multi-headed composite model 314. The composite dataset 302 may include a plurality of training data objects. Each training data object may include a mapped text sequence. A mapped text sequence, for example, may include a text sequence and a training label corresponding to the text sequence. For example, the composite dataset 302 may include a plurality of training data objects that respectively include a plurality of different text sequences from one or more different third parties 308. Each training data object may include (i) a text sequence that is descriptive of a third-party code from a third-party coding set of a respective third party and (ii) a corresponding first-party label that is descriptive of a canonical code of a canonical coding set. The canonical coding set, for example, may include a predefined third-party agnostic label for the third-party code.

The composite dataset 302 may be based on the prediction domain. In some examples, in a clinical domain, the composite dataset 302 may include a plurality of mapped text sequences from a plurality of different medical resources. Each mapped text sequence may include (i) a text sequence that is descriptive of a medical code unique to a medical resource and (ii) a corresponding first-party label that is descriptive of a canonical code of a universal ontology. The canonical code, for example, may include a predefined ontology agnostic representation of a medical code otherwise unique to the medical resource and incompatible with other parties.

In some embodiments, a third party is an entity that is associated with a third-party coding set. The third party may be configured to generate, maintain, store, and/or the like, data that is defined by a third-party coding set. The third-party coding set may be at least partially incompatible with a plurality of other third-party coding sets leveraged by a plurality of related third parties.

The third party may be based on the prediction domain. In some examples, the third party may include a clinical provider that is configured to generate, maintain, store, and/or the like, medical data, such as medical claims, and/or the like, that is coded according to a medical, external, coding set. In some examples, the third-party coding set may be unique to the third party. By way of example, the third party may be one of a variety of medical sources, such as government and/or private entities that use medical coding sets, such as International Classification of Disease, Tenth Revision (ICD10), Logical Observation Identifiers Names and Codes (LOINC), Systemized Nomenclature of Medicine—Clinical Terms (SNOMED CT), and/or the like.

In some embodiments, a first party is an entity that is associated with a canonical dataset for standardizing a plurality of incompatible coding formats into one, universal coding set. The first party may be configured to generate, maintain, store, convert, and/or the like, data that is defined by a first-party coding set. The first-party coding set may include a canonical coding set for standardizing a plurality of at least partially incompatible third-party coding sets leveraged by the plurality of third parties 308. In some examples, the first party may be configured to generate first-party data from third-party data coded in accordance with one or more of the third-party coding sets. For example, the first party may leverage the multi-headed composite model 314 to transform a third-party dataset to a canonical dataset that represents a standardized version of the third-party dataset.

The first party may be based on the prediction domain. In some examples, the first party may include a clinical provider that is configured to aggregate data from a plurality of third-party clinical providers that leverage a plurality of incompatible, external, medical coding sets.

In some embodiments, the canonical dataset is a data entity that describes a first-party dataset that includes standardized data from across the plurality of third parties 308. The canonical dataset may include a plurality of canonical data objects. In some examples, the canonical dataset may include third-party data that is transformed from a third-party coding set to a canonical coding set. For example, each canonical data object may include a first-party label that describes a canonical code from a canonical coding set.

In some embodiments, the first-party label is a data entity that describes a canonical label for a data object of a canonical dataset. The first-party label, for example, may describe a canonical code from a canonical coding set. For instance, the first-party label may include a text description for the canonical code. The text description may include a predefined, ontology agnostic description for the canonical code.

The first-party label may be based on the prediction domain. In some examples, in a clinical domain, a first-party label may include a standardized label for a universal medical ontology that is generalizable to each of a plurality of incompatible medical coding sets.

In some examples, the prediction domain may include a plurality of predictive categories. Each predictive category may include a plurality of first-party labels. In some examples, a predictive category may include a plurality of first-party labels that are predefined by the first party.

In some embodiments, a predictive category is a data entity that describes a group of first-party labels. For example, a first-party label may be one of a plurality of first-party labels defined by a canonical coding set. The plurality of first-party labels may be separated into different predictive categories based on one or more label attributes, such as a semantic type, syntactic type, text similarity, and/or the like. For instance, a predictive category may include a subset of the plurality of first-party labels that are associated with a respective semantic type.

A predictive category may be based on the prediction domain. In some examples, in a clinical domain, the predictive category may include an ontology category of a universal ontology. By way of example, the predictive category may include one of fifteen groups of internal coding sets. In some examples, each of the fifteen groups of internal coding sets may be mapped to thirty-seven different, inconsistent third-party coding sets.

In some embodiments, the plurality of training datasets 326 include a training dataset for each predictive category of a plurality of predictive categories for a prediction domain. Each training dataset is a data entity that describes a portion of the composite dataset 302. For example, a training dataset may include a subset of training data objects from the composite dataset 302 that correspond to a particular predictive category. For instance, a training dataset may include a subset of mapped text sequences that correspond to a particular predictive category. The subset of mapped text sequences, for example, may each include a first-party label that corresponds to the particular predictive category. In some examples, the composite dataset 302 may be divided into the plurality of training datasets 326. Each of the plurality of training datasets 326 may correspond to one of a plurality of predictive categories for the prediction domain.

A training dataset may be based on the prediction domain. In some examples, in a clinical domain, the training dataset may include a portion of training data that corresponds to an ontology category of a universal ontology. For instance, a predictive category may be indicative of an ontology category for a prediction domain. The training dataset for the predictive category may include a plurality of mapped text sequences for the ontology category. In the event that the universal ontology has fifteen ontology categories, the composite dataset 302 may be divided into fifteen training datasets, one for each of the fifteen ontology categories. By way of example, the ontology categories may be based on semantic categories of the universal ontology, and the composite dataset 302 may be divided into fifteen datasets, each directed to a semantic category (e.g., Condition, Procedure, Medication, Observation, etc.) of a universal ontology.

In some embodiments, during the teacher training phase 320, a plurality of teacher models 306a-c is generated that corresponds to a plurality of predictive categories. Each of the plurality of teacher models may include a deep neural network with a plurality of attention layers.

The plurality of teacher models 306a-c may be generated based on the plurality of training datasets 326. For example, the plurality of teacher models 306a-c may include a teacher model for each predictive category of the plurality of predictive categories. A first teacher model 306a, for example, may correspond to a first predictive category associated with the first training dataset, a second teacher model 306d may correspond to a second predictive category associated with the second training dataset, a third teacher model 306e may correspond to a third predictive category associated with the third training dataset, and/or the like.

In some embodiments, each teacher model is trained by optimizing a triplet loss for a particular training dataset of the plurality of training datasets. For example, the first teacher model 306a may be trained to generate an output embedding for a text sequence of a first predictive category by optimizing a triplet loss over a plurality of mapped text sequences from the first training dataset. As another example, the second teacher model 306b may be trained to generate an output embedding for a text sequence of a second predictive category by optimizing a triplet loss over a plurality of mapped text sequences from the second training dataset. In addition, or alternatively, the third teacher model 306e may be trained to generate an output embedding for a text sequence of a third predictive category by optimizing a triplet loss over a plurality of mapped text sequences from the third training dataset. This process may be repeated for each training dataset to generate a teacher model corresponding to each predictive category of the prediction domain.

In some embodiments, during the composite model training phase 322, the multi-headed composite model 314 is generated based on a plurality of trained parameters for each of the plurality of teacher models 306a-c. For example, the multi-headed composite model 314 may include a plurality of model heads 316a-c that correspond to the plurality of teacher models 306a-c. In addition, or alternatively, the multi-headed composite model 314 may include a model body 312 that corresponds to at least one of the plurality of teacher models 306a-c.

In some embodiments, the multi-headed composite model 314 refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The multi-headed composite model 314 may include a multi-headed machine learning model configured, trained, and/or the like, to generate an output embedding 328 for a text input that may be leveraged for a classification, prediction, and/or one or more other computer text interpretation tasks. The multi-headed composite model 314 may include one or more of any type of machine learning model including one or more supervised, unsupervised, semi-supervised, reinforcement learning models, and/or the like. In some examples, the multi-headed composite model 314 may include multiple models configured to perform one or more different stages of an embedding and/or classification process.

In some embodiments, the multi-headed composite model 314 includes a neural network with a plurality of attention layers. For example, the multi-headed composite model 314 may include a model body 312 and/or a plurality of model heads 316a-c that may each form a portion of the multi-headed composite model 314. In some examples, the model body 312 may include a first plurality of attention blocks, m, that are common to all inputs to the multi-headed composite model 314. In some examples, each of the plurality of model heads 316a-c may include a second plurality of attention blocks, h, that are specific to a particular type of input.

In some embodiments, the multi-headed composite model 314 comprises a neural network architecture that is trained using one or more machine learning training techniques. In some examples, one or more portions of the neural network architecture may be individually and/or jointly trained using one or more different training techniques. For example, the multi-headed composite model may be trained over a multistage training technique. During a first stage of the multistage training technique, the composite model training phase 322, the model body 312 and/or each of the model heads 316a-c may be individually trained using knowledge transfer techniques, such as teacher-student transfer learning. During a second stage of the multistage training technique, the model refinement phase 324, the model body 312 and/or each of the model heads 316a-c may be jointly trained using one or more knowledge distillation techniques, such as teacher-student knowledge distillation.

In some embodiments, during each stage of the multistage training technique, the multi-headed composite model 314 is trained by transferring knowledge from the teacher models 306a-c previously trained in a teacher training phase 320. In some examples, the model body 312 may be trained based on one or more trained parameters of an optimal teacher model (e.g., first teacher model 306a) that satisfies a knowledge threshold. The knowledge threshold, for example, may be indicative of a size of a training dataset for the optimal teacher model. In some examples, the knowledge transfer threshold may be relative to the plurality of teacher models 306a-c. By way of example, the knowledge transfer threshold may be indicative of the largest training dataset of the plurality of training datasets 326 respectively used to train the plurality of teacher models 306a-c. In such a case, the optimal teacher model may include a teacher model that is trained by the largest training dataset and, in some examples, is considered the most knowledgeable teacher model.

In some embodiments, the model body 312 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The model body 312 may include a first portion of the multi-headed composite model 314 that is configured, trained, and/or the like to generate an intermediate output for an input data object. The model body 312 may include one or more of any type of machine learning model including one or more supervised, unsupervised, semi-supervised, reinforcement learning models, and/or the like. In some examples, the model body 312 may include a first plurality of attention blocks, m, that are common to all inputs to the multi-headed composite model 314.

In some embodiments, each model head is trained based on one or more trained parameters of a respective teacher model. In some embodiments, a model head is a data entity that describes parameters, hyper-parameters, and/or defined operations of a rules-based and/or machine learning model (e.g., model including at least one of one or more rule-based layers, one or more layers that depend on trained parameters, coefficients, and/or the like). A model head may include a second portion of the multi-headed composite model 314 that is configured, trained, and/or the like to generate an output embedding 328 for an input data object based on an intermediate output of the model body 312. A model head may include one or more of any type of machine learning model including one or more supervised, unsupervised, semi-supervised, reinforcement learning models, and/or the like. In some examples, the model head may include a second plurality of attention blocks, h, that are specific to a particular type of input.

In some embodiments, during the composite model training phase 322, a base composite model 310 is generated for the multi-headed composite model 314. The base composite model 310 may include an initial model body, initial model heads, and a gate function for selecting at least one of the model heads for processing an input data object. During the composite model training phase 322, the parameters of the initial model body and initial model heads may be iteratively updated by transferring the trained parameters of the teacher models 306a-c to generate the model body 312 and model heads 316a-c. The model body 312, model heads 316a-c, and gate function may then be jointly refined during the model refinement phase 324.

In some embodiments, during the model refinement phase 324, the multi-headed composite model 314 is jointly trained using the plurality of teacher models 306a-c. For example, the multi-headed composite model 314 may be fine-tuned using knowledge distillation techniques.

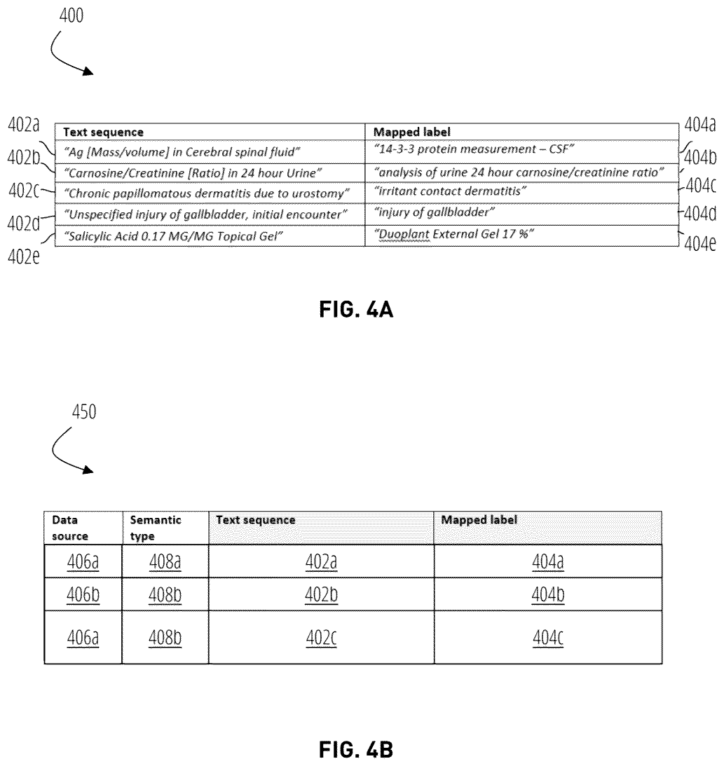

Once trained, the multi-headed composite model 314 may be configured to generate an output embedding 328 for any type of text input. In some examples, the type of text input may depend on the composite dataset 302 and/or the one or more text sequences thereof. For example, the multi-headed composite model 314 may be configured to generate a different output embedding 328 for any type of text input based on the prediction domain of the composite dataset 302. In some examples, the prediction domain may include a clinical prediction domain. An example of a portion of a composite dataset 302 for a clinical prediction domain will now further be described with reference to FIGS. 4A-B.

FIG. 4A provides an operational example 400 of mapped text sequences in accordance with some embodiments discussed herein. The mapped text sequences may include a plurality of sequence-label pairs. Each sequence-label pair may include a text sequence 402a-e and a training label 404a-e. By way of example, a first mapped text sequence may include a first text sequence 402a and a corresponding first training label 404a. A second mapped text sequence may include a second text sequence 402b and a corresponding second training label 404b. A third mapped text sequence may include a third text sequence 402c and a corresponding third training label 404c. A fourth mapped text sequence may include a fourth text sequence 402d and a corresponding fourth training label 404d. A fifth mapped text sequence may include a fifth text sequence 402e and a corresponding fifth training label 404c.

In some embodiments, a mapped text sequence is a data entity that describes a labeled input for training a machine learning model. A mapped text sequence may include a text sequence and/or a corresponding label for the text sequence. For example, a text sequence may include a first sequence of characters, numbers, words, symbols, and/or the like, that describe a particular third-party code from a third-party coding set. The corresponding label may include second sequence of characters, numbers, words, symbols, and/or the like, that describe a canonical code from a canonical coding set. By way of example, a mapped text sequence may include a third-party text sequence from a third party and a corresponding first-party label.

In some embodiments, a plurality of mapped text sequences are received, determined, and/or otherwise accessed to generate a composite dataset for training a multi-headed composite model. In such a case, each of the mapped text sequences may include a text sequence from a third party and a training label corresponding to the text sequence.

In some embodiments, a training label is a data entity that describes a first-party label for a mapped text sequence. The training label may include a first-party label that corresponds to a particular text sequence of a mapped text sequence. In some examples, the training label may be previously assigned to a text sequence based on a desired output of the multi-headed composite model. By way of example, a training label may identify a desired first-party label for a particular text sequence from a third party.

The text sequences and/or training labels for each of the mapped text sequences may depend on the prediction domain. In some examples, in a clinical prediction domain, the text sequences may include a medical code description for a third-party medical code. In such a case, a corresponding training label may include a canonical code description for a first-party canonical medical code. In this manner, by matching medical code descriptions to canonical code descriptions, a machine learning model, such as the multi-headed composite model, may be trained to identify a canonical code for a third-party medical code. While a clinical prediction domain is illustrated for example purposes, it is noted that these techniques may be applied to any prediction domain, including financial services, autonomous systems, and/or the like, for transforming a plurality of incompatible, disparate, coding sets into one canonical dataset.

In some embodiments, the plurality of mapped text sequences is grouped into a plurality of training datasets. In some examples, the plurality of text sequences may be grouped into the plurality of training datasets based on a plurality of predictive categories. The predictive categories may depend on the prediction domain. In a clinical prediction domain, for example, the plurality of prediction categories may include ontology categories that are based on a semantic type of a text sequence. An example of plurality of grouped mapped text sequences for a clinical prediction domain will now further be described with reference to FIG. 4B.

FIG. 4B provides an operational example 450 of mapped text sequences within one or more predictive categories in accordance with some embodiments discussed herein. The mapped text sequences, for example, may include a first mapped text sequence that corresponds to a first predictive category and a second mapped sequence and/or a third mapped sequence that correspond to a second predictive category. Two predictive categories and two third parties are illustrated for example purposes. Any number of predictive categories and/or third parties may be accommodated. As described herein, the number and/or types of predictive categories and/or third parties may be based on the prediction domain.

In some embodiments, a mapped text sequence includes a text sequence from a third party. A third party, for example, may include a data source for the text sequence. In some examples, a third party may provide, generate, and/or maintain a plurality of text sequences. For example, a first mapped text sequence may include a first text sequence 402a that originates from a first third party 406a. As another example, a second mapped text sequence may include a second text sequence 402b that originates from a second third party 406b. As yet another example, a third mapped text sequence may include a third text sequence 402c that originates from the first third party 406a.

In some embodiments, the text sequence and/or training label of a mapped text sequence corresponds to a predictive category. For example, the predictive category for the mapped text sequence may be based on one or more attributes of the text sequence, training label, and/or third party. In some examples, the predictive category may be based on a semantic type of the text sequence, training label, and/or a third-party dataset corresponding to the text sequence.

By way of example, a first mapped text sequence may include a first text sequence 402a from a first third-party dataset that corresponds to a first semantic type 408a. In such a case, the first mapped text sequence may be assigned to a first predictive category. As another example, the second mapped text sequence may include a second text sequence 402b from a second third-party dataset that corresponds to a second semantic type 408b. In such a case, the second mapped text sequence may be assigned to a second predictive category different from the first predictive category. As yet another example, the third mapped text sequence may include a third text sequence 402c from a third third-party dataset that corresponds to the second semantic type 408b. In such a case, the third mapped text sequence may be assigned to the second predictive category with the second mapped text sequence.

In some embodiments, a semantic type for a text sequence, training label, and/or a third-party dataset are based on the prediction domain. For instance, a semantic type may be descriptive of a particular process, state, action, and/or action process that is related to a particular prediction domain. By way of example, in a clinical prediction domain, one or more example semantic types may include a condition type, a procedure type, a medication type, an observation type, an organism type, a physical object type, a substance type, and/or the like. Each semantic type may describe a general state, action, or thing that is recorded in a clinical prediction domain.

In some embodiments, a third party includes, generates, maintains, or otherwise has access to a plurality of third-party datasets. In some examples, each of the third-party datasets may correspond to a semantic type of data. By way of example, a third party may maintain a first dataset with a plurality of data objects that describe one or more conditions, a second dataset with a plurality of data objects that describe one or more procedures, and/or the like. Each third-party dataset may include a plurality of text sequences that are associated with a respective third-party category.

In some embodiments, a mapped text sequence is assigned to a predictive category based on a third-party category of a third-party dataset corresponding to the text sequence of the mapped text sequence. By way of example, the mapped text sequence may be assigned to a predictive category based on a semantic similarity between the third-party category and the predictive category.

In some embodiments, a plurality of training datasets is generated from a composite dataset by assigning each of the mapped text sequences to a respective predictive category. For example, each training dataset may correspond to a predictive category. In some examples, the plurality of training datasets may be previously generated based on a semantic similarity between a third-party category and a predictive category. For instance, each mapped text sequence of the composite dataset may be assigned to a training dataset based on a semantic similarity between a third-party category associated with the mapped text sequence and a predictive category associated with the training dataset.

In this manner, a plurality of training datasets may be generated during a data collection phase of a multistage training technique for generating a multi-headed composite model. The output of the data collection phase may be a plurality of datasets for training teacher models, one dataset for each teacher model. In some examples, the plurality of training datasets may include fifteen total datasets that may be generated to train fifteen teacher models for automated ontology mapping. By way of example, the fifteen teacher models may correspond to the fifteen ontology categories (e.g., canonical ontology categories, etc.). Each training dataset may include a collection of text sequences as well as mappings. For instance, an example condition dataset may include of 226,932 text sequences with mappings, of which 96,034 from ICD 10 conditions mappings and 130,898 from SNOMED CT conditions mappings.

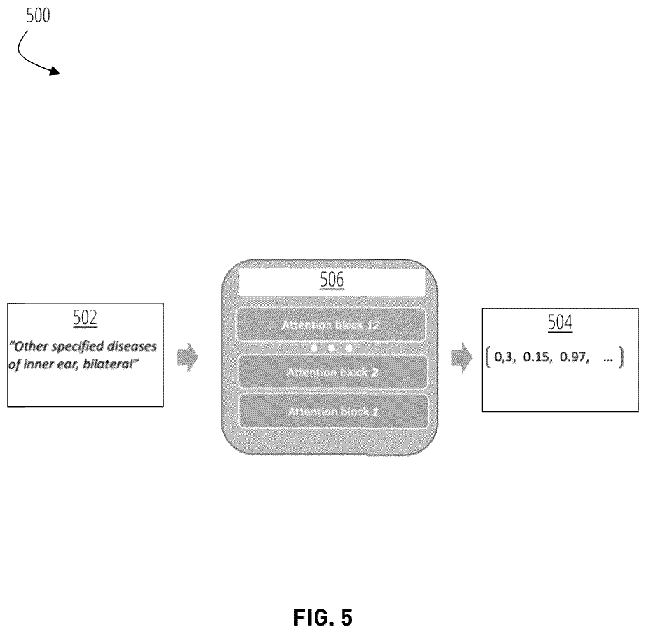

In some embodiments, each training dataset is used to generate a teacher model for a respective predictive category. An example of a teacher model will now further be described with reference to FIG. 5.

FIG. 5 provides an operational example 500 of a teacher model in accordance with some embodiments discussed herein. Once trained, the teacher model 506 may be configured to receive a text sequence 502 and output a teacher output embedding 504 based on the text sequence 502. As described herein, the trained parameters of the teacher model 506 and the teacher output embedding 504 generated by the teacher model 506 may be leveraged to train the multi-headed composite model.

In some embodiments, the teacher model 506 refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The teacher model 506 may include a machine learning model that is configured, trained, and/or the like to generate a teacher output embedding 504 for a text input, such as the text sequence 502, that may be leveraged for a classification, predictive, and/or one or more other computing tasks. The teacher model 506 may include one or more of any type of machine learning model including one or more supervised, unsupervised, semi-supervised, reinforcement learning models, and/or the like.

In some embodiments, the teacher model 506 includes a neural network that is trained to generate a teacher output embedding 504 for a text sequence within a particular predictive category. The teacher model 506, for example, may include a deep neural network with a set of attention blocks used to transform a text sequence 502 into a teacher output embedding 504. The attention blocks, for example, may include a self-attention layer, a first normalization layer, a fully connected feed forward network, a second normalization layer, and/or the like.

The teacher model 506 may be trained using one or more machine learning training techniques. By way of example, the teacher model may be trained using one or more supervised machine learning techniques using a training dataset for a particular predictive category. The one or more supervised machine learning training techniques may include any of a plurality of different machine learning techniques, such as triplet loss training, and/or the like. In some examples, the teacher model 506 may be specially configured for one of a plurality of predictive categories of a prediction domain. For example, a different teacher model may be separately trained for each predictive category of the prediction domain.

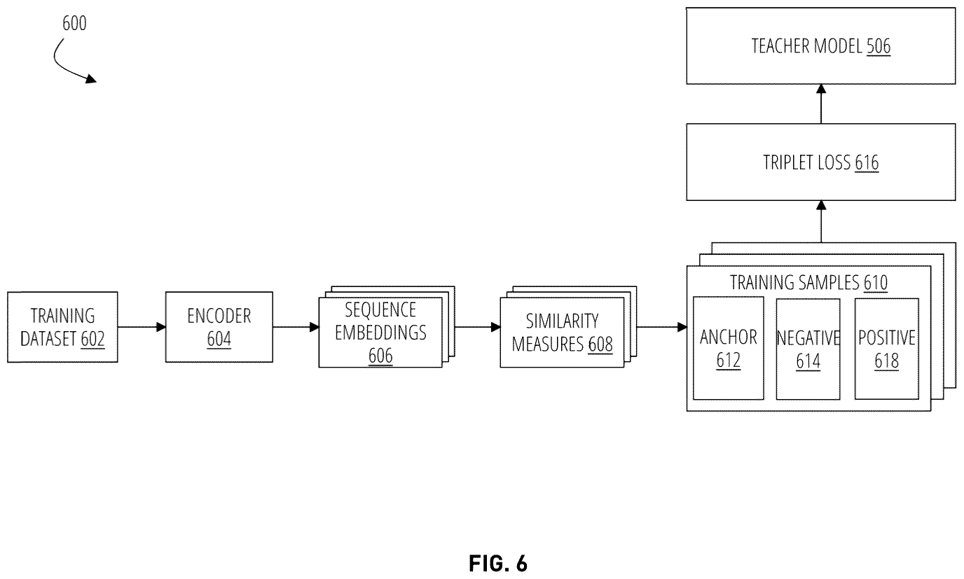

In some embodiments, the teacher model 506 is trained using one or more machine learning training techniques. For instance, the teacher model 506 may be trained, during one or more teacher training phases, based on a triplet loss. An example of a teacher training phase will now further be described with reference to FIG. 6.

FIG. 6 provides a dataflow diagram 600 of a teacher training phase in accordance with some embodiments discussed herein. The dataflow diagram 600 includes a plurality of data structures generated and/or leveraged during one or more iterative teacher training operations to refine a teacher model 506 configured to generate teacher output embeddings for text sequences of a particular predictive category. To do so, the teacher model 506 may be trained using a triplet loss 616 generated based on a particular training dataset 602 corresponding to the particular predictive category. The particular training dataset 602 for the teacher model 506, for example, may include a plurality of text sequences and a plurality of training labels.

In some embodiments, the teacher training phase may include a loop of three sequential operations. The three sequential operations, for example, may include the creation of teacher models, the creation of triplet loss training samples 610 and evaluation samples, and the training of the teacher model 506 with the triplet loss 616 generated using the triplet loss training samples 610. A training sample 610, for example, may include an anchor embedding for an anchor text sequence 612, a negative embedding for a negative training label 614, and/or a positive embedding, for a positive training label 618.

In some embodiments, the triplet loss 616 is a data entity that describes a model loss for training a teacher model 506. The triplet loss 616 may be generated using a triplet loss function that is configured to compare a plurality of text sequences and/or training labels. For example, the triplet loss 616 may be generated based on a comparison between an anchor text sequence to a positive and negative label. By way of example, the triplet loss 616 may be based on (i) a first distance between the anchor text sequence 612 and a positive training label 618 and (ii) a second distance between the anchor text sequence 612 and the negative training label 614. In some examples, the distances may be based on a distance between one or more text sequence embeddings 606 for the anchor text sequence 612, the positive training label 618, and/or the negative training label 614. In some examples, a teacher model may be trained by minimizing the first distance, while maximizing the second distance.

In some embodiments, the triplet loss 616 for the teacher model 506 is based on (i) a first distance between an anchor text sequence 612 and a positive training label 618 and (ii) a second distance between the anchor text sequence and a negative training label. In some examples, the teacher model 506 may be trained by optimizing the triplet loss 616. Optimizing the triplet loss 616 may include minimizing the first distance and/or maximizing the second distance. By way of example, the teacher model 506 may be trained by minimizing the distance between an external text sequence (e.g., anchor text sequence 612) and mapped internal text sequence (e.g., positive example) while maximizing the distance between the external text sequence (e.g., anchor text sequence 612) and other un-relevant internal text sequence (e.g., negative example). In some examples, the distances between text sequences may be generated by a pooling layer from an encoder 604, such as a clinical encoder model in a clinical prediction domain, with an architecture similar to the teacher model 506. The triplet loss function may be defined as follows:

$$ℒ ( A , P , N ) = max ( {‖ f ( A ) - f ( P ) ‖}^{2} - {‖ f ( A ) - f ( N ) ‖}^{2} + α , 0 )$$

where A is an anchor embedding, P is a positive embedding, N is a negative embedding, α is a margin between positive and negative pairs, and f is an embedding function.

In some embodiments, the anchor text sequence 612 is a data entity that describes a baseline input for training a machine learning model. The anchor text sequence 612 may include a text sequence from a mapped text sequence.

In some embodiments, the anchor embedding is a data entity that describes an embedding for the anchor text sequence 612. The anchor embedding, for example, may include a text sequence embedding for the anchor text sequence 612. For example, the anchor embedding may include a real-valued vector that encodes one or more attributes for the anchor text sequence 612. The anchor embedding may be generated for the anchor text sequence using the teacher model 506 and/or an encoder 604 with an architecture similar to the teacher model 506.

In some embodiments, the positive training label 618 is a data entity that describes a positive input for training a machine learning model. The positive training label 618 may include a training label from the mapped text sequence that includes the anchor text sequence 612.

In some embodiments, the positive embedding is a data entity that describes an embedding for the positive training label 618. The positive embedding, for example, may include a text sequence embedding for the positive training label 618. For example, the positive embedding may include a real-valued vector that encodes one or more attributes for the positive training label 618. The positive embedding may be generated for the positive training label using the teacher model and/or the encoder 604.

In some embodiments, the negative training label 614 is a data entity that describes a negative input for training the machine learning model. The negative training label 614 may include a training label that is not included in the mapped text sequence that includes the anchor text sequence 612.

In some embodiments, the negative embedding is a data entity that describes an embedding for the negative training label 614. The negative embedding, for example, may include a text sequence embedding for the negative training label. For example, the negative embedding may include a real-valued vector that encodes one or more attributes for the negative training label 614. The negative embedding may be generated for the negative training label 614 using the teacher model 506 and/or the encoder 604.

In some embodiments, the encoder 604 is a machine learning encoder model with an architecture similar to the teacher model 506. The encoder 604 may be leveraged to generate a plurality of text sequence embeddings 606 for a plurality of text sequences and/or a plurality of training labels from the particular training dataset 602. In some examples, a plurality of similarity measures 608 may be generated between each of the text sequence embeddings 606. For example, a first similarity measure, for example, may include the first distance and a second distance for one or more training samples 610. The first distance may be based on a first cosine similarity distance between an anchor embedding corresponding to the anchor text sequence 612 and a positive embedding corresponding to the positive training label 618. A second distance may be based on a second cosine similarity distance between the anchor embedding and a negative embedding corresponding to the negative training label 614.

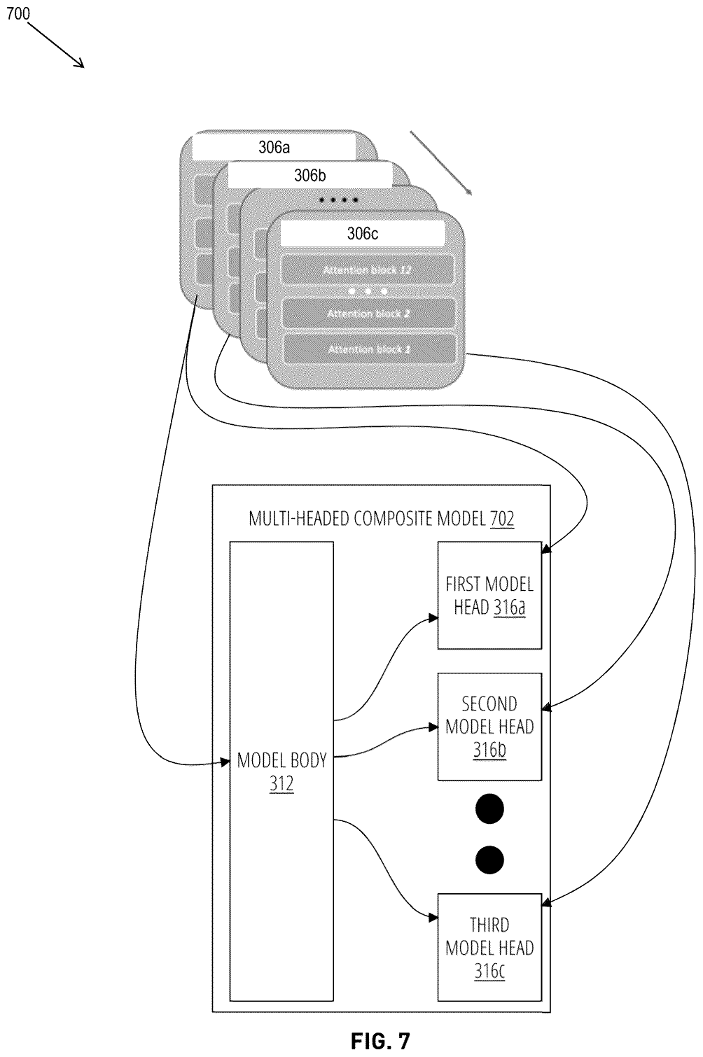

In this manner, in some embodiments, a plurality of teacher models is generated using a plurality of training datasets. As described herein, the plurality of teacher models may be leveraged, during one or more model training phases, to generate a multi-headed composite model for a prediction domain corresponding to the composite dataset. An example of a composite model training phase for training the multi-headed composite model will now further be described with reference to FIG. 7.

FIG. 7 provides a dataflow diagram 700 of a composite model training phase of a model training process in accordance with some embodiments discussed herein. The dataflow diagram 700 includes a plurality of data structures generated and/or leveraged during a composite model training phase for a multi-headed composite model 314. For example, the multi-headed composite model 314 may be trained by leveraging a plurality of teacher models 306a-c previously trained in accordance with some embodiments discussed herein.

As described herein, in some embodiments, the multi-headed composite model 314 includes a model body 312 and a plurality of model heads 316a-c. In some examples, each portion of the multi-headed composite model 314 may be generated using one or more of the teacher models 306a-c. The multi-headed composite model 314 may be generated through two sequential operations including (i) a creation operation for generating the base composite model and (ii) a knowledge transfer operation for transferring knowledge from the teacher models 306a-c to one or more portions of the base composite model.

In some embodiments, the model body 312 is generated based on an optimal teacher model from the teacher models 306a-c. By way of example, the optimal teacher model may include the first teacher model 306a from the teacher models 306a-c. The optimal teacher model may be identified from the teacher models 306a-c based on the training datasets for the teacher models 306a-c. In some examples, the optimal teacher model may be identified based on a number of mapped text sequences in the training datasets that correspond to the teacher models. By way of example, the optimal teacher model may include the teacher model with the largest training dataset. In this manner, the teacher model with the largest training dataset may be selected from the pool and used to transfer its parameters to the model body 312 of the multi-headed composite model 314. By way of example, the model body 312 may be generated based on the plurality of trained parameters for the optimal teacher model.

In some embodiments, each of the plurality of model heads 316a-c are generated based on a respective one of the teacher models 306a-c. For example, the model heads 316a-c may be iteratively generated based on a plurality of trained parameters for each of the plurality of teacher models 306a-c. By way of example, a model head may be generated based on the plurality of trained parameters for a respective teacher model of the plurality of teacher models 306a-c. For instance, a first model head 316a may be generated based on a plurality of trained parameters from the first teacher model 306a, a second model head 316b may be generated based on a plurality of trained parameters from the second teacher model 306b, a third model head 316c may be generated based on a plurality pluralities of trained parameters from the third teacher model 306c, and/or the like.

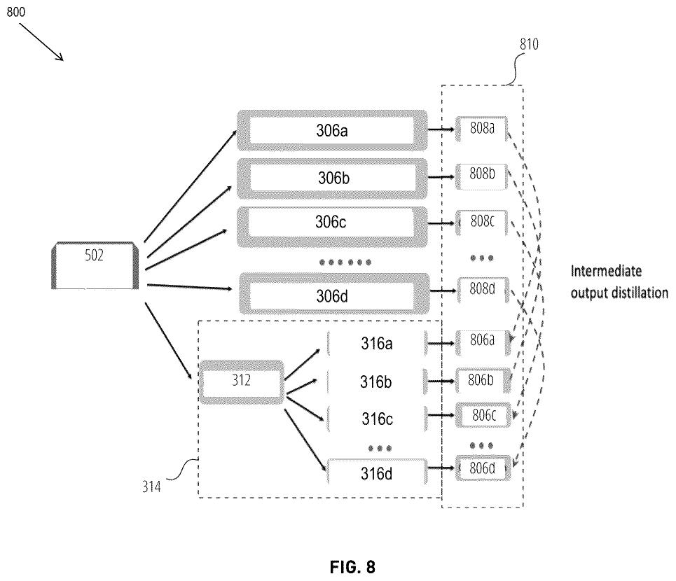

In this manner, in some embodiments, the multi-headed composite model 314 is initialized using transfer training techniques that leverage one or more parameters of the plurality of teacher models 306a-c. As described herein, the multi-headed composite model 314 may be refined, during one or more refinement training phases, to improve the predictive performance of the multi-headed composite model 314. An example of a refinement training phase of the multi-headed composite model 314 will now further be described with reference to FIG. 8.

FIG. 8 provides a dataflow diagram 800 of a model refinement phase of a model training process in accordance with some embodiments discussed herein. The dataflow diagram 800 includes a plurality of data structures generated and/or leveraged during a model refinement phase for a multi-headed composite model 314. For example, the multi-headed composite model 314 may be trained by leveraging a plurality of teacher models 306a-d previously trained in accordance with some embodiments discussed herein.

In some embodiments, during the model refinement phase, a text sequence 502 may be processed by the multi-headed composite model 314 and one or more of the teacher models 306a-d to generate a plurality of output embeddings 810. The plurality of output embeddings 810 may include (i) a plurality of head output embeddings 806a-d generated by the plurality of model heads 316a-d of the multi-headed composite model 314 and (ii) a plurality of teacher output embeddings 808a-d generated by the plurality of teacher models 306a-d. In some examples, the plurality of teacher output embeddings 808a-d may be compared to the plurality of head output embeddings 806a-d to refine the multi-headed composite model 314 based on the knowledge of the teacher models 306a-d. By way of example, a first head output embedding 806a may be generated using a first model head 316a of the multi-headed composite model 314 and a first teacher output embedding 808a may be generated using a first teacher model 306a of the plurality of teacher models 306a-c. In some examples, one or more parameters of the multi-headed composite model 314 (e.g., model body 312, first model head 316a, gate function, etc.) may be updated based on a comparison between the first head output embedding 806a and the first teacher output embedding 808a. In this manner, the multi-headed composite model 314 may be refined using one or more teacher-student knowledge distillation techniques.

By way of example, in some embodiments, during a teacher-student knowledge distillation process the individual intermediate outputs of each of the teacher models 306a-d are distilled into respected light-weight model heads 316a-d of the multi-headed composite model 314. In some embodiments, the teacher models 306a-d may include a heavy weight head which may include many attention blocks, such as twenty or more, while the model heads 316a-d may include lightweight heads which may include few attention blocks, such as 3. By refining the multi-headed composite model 314 based on the outputs of the teacher modes, some embodiments of the present disclosure enable the capturing of knowledge from large models or sets of models by a single smaller model with comparable performance that can be practically deployed under real-world constraints. In this manner, some embodiments of the present disclosure allow for the creation of more efficient models that could be deployed on devices with limited resources while with superior performance compared with traditional models.

In some embodiments, the multi-headed composite model 314 may be jointly trained based on a composite loss function. The composite loss function may be a data entity that describes parameters, hyper-parameters, and/or defined operations of a model training and/or evaluation techniques. The composite loss function, for example, may include a training technique, such as knowledge distillation, configured to generate a model loss for the multi-headed composite model. The composite loss function may include a teacher-student knowledge distillation process in which individual intermediate outputs of each of a plurality of teacher models is distilled into a respective model head of the multi-headed composite model. To do so, the composite loss function may be configured to generate a model loss for the composite model based on one or more outputs of the plurality of teacher models. The composite loss function, for example, may include a Kullback-Leibler divergence loss, a Mean-Square Error loss, a distance-based loss, and/or the like, and/or the model loss may include an Kullback-Leibler Divergence Loss, a Mean-Square Error loss, a distance-based loss, and/or the like.

In this manner, knowledge distillation may be used to capture the knowledge from a large model (e.g., a teacher model) or set of models (e.g., a plurality of teacher models) to a single smaller model (e.g., a model head) with comparable performance that can be practically deployed under real-world constraints. To do so, intermediate outputs of larger, teacher models, may be used to train a smaller, model head. In some examples, the model heads and model body of the multi-headed composite model may be jointly trained to reduce, minimize, and/or maximize the model loss. By way of example, the multi-headed composite model 314 may be trained to minimize the model loss.

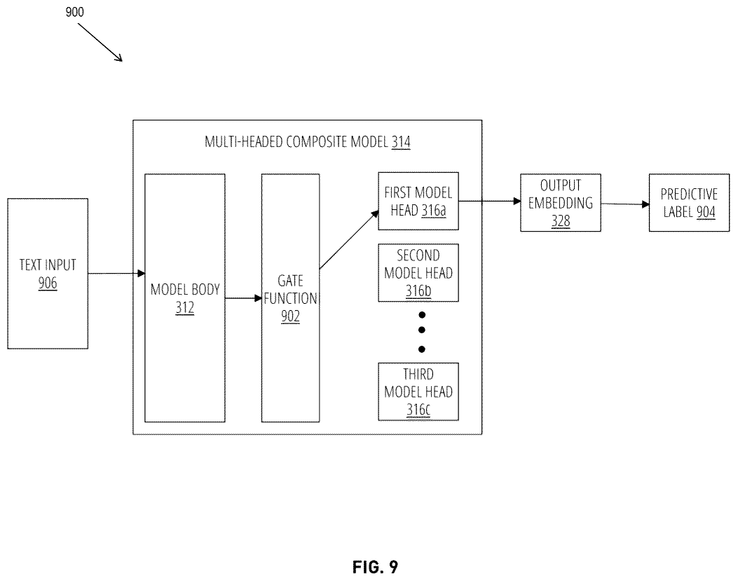

In this manner, in some embodiments, a multi-headed composite model is generated for a prediction domain. As described herein, the multi-headed composite model may be leveraged, during one or more operational phases, to generate an output embedding for a third-party text sequence that may be used for a plurality of different predictive actions. Example operations of the multi-headed composite model will now further be described with reference to FIG. 9.

FIG. 9 provides a dataflow diagram 900 of an operation of a multi-headed composite model in accordance with some embodiments discussed herein. The dataflow diagram 900 includes a plurality of data structures generated and/or leveraged during the operation of the multi-headed composite model. For example, the multi-headed composite model 314 may be configured to receive an input data object and process the input data object to transform a text input 906 of the input data object to an output embedding 328. The output embedding 328 may be leveraged for a plurality of computing tasks including, for example, generating a predictive label 904 for the text input 906.

In some embodiments, an input data object is received. The input data object may include a text input 906, a predictive category for the text input, and/or any other inputs, characteristics, attributes, and/or the like for the text input 906. For example, the input data object may include the text input 906 and/or contextual data indicative of a predictive category for the text input 906.

In some embodiments, the input data object is a data entity that describes an input to the multi-headed composite model 314. In some examples, the input data object may include a text input 906 and/or contextual data indicative of a predictive category for the text input 906. By way of example, the text input 906 may include a text chunk that is associated with any of a plurality of third parties and/or third-party coding sets thereof. By way of example, in a clinical prediction domain, a text input 906 may include a text description (e.g., “Unspecified injury of gallbladder, initial encounter,” etc.) that describes a third-party code from a third-party dataset. The predictive category may include a predictive category that corresponds to the text input 906.

In some examples, the contextual data may include user input for the text input 906. The user input may be indicative of the predictive category. In some examples, the predictive category may be based on the user input.

In addition, or alternatively, the contextual data may be indicative of one or more characteristics of the text input 906. By way of example, the text input 906 may be associated with a third-party category. The third-party category, for example, may be based on a third-party dataset from which the text input 906 originated. The contextual data may be indicative of the third-party category, the third-party dataset, and/or the like. In some examples, the predictive category may be based on the third-party category. For instance, the predictive category may be based on a semantic mapping between a plurality of third-party categories and a plurality of predictive categories.

In some embodiments, an output embedding 328 is generated for the text input 906 using the multi-headed composite model 314.

In some embodiments, the output embedding 328 is a data entity that describes an output of the multi-headed composite model 314. The output embedding 328 may include a vectorized representation of the text input 906 (e.g. [0.13, 0.28, 0.97, . . . ], etc.). In some examples, the output embedding 328 has a 768 dimensionality. The output embedding 328 may include a contextual representation with semantics that allow ontology mapping (different ways to represent/write the chunks that will be mapped to the core concepts or meanings). This vectorized representation can be used as input for many other downstream tasks including ontology mapping as described herein.

In some examples, the output embedding 328 may be based on the predictive category. For example, the multi-headed composite model may include a model body 312, a plurality of model heads 316a-c, and/or a gate function 902. The text input 906 may be processed with at least one model head (e.g., the first model head 316a) of the multi-headed composite model 314 based on the predictive category.

By way of example, as described herein, each of the plurality of model heads 316a-c may correspond to a particular predictive category of a plurality of predictive categories of a prediction domain. The multi-headed composite model 314 may be configured to generate, using the model body 312, an intermediate output for the text input 906. The multi-headed composite model 314 may be configured to select, using the gate function 902, the at least one model head (e.g., the first model head 316a) for processing the intermediate output based on the predictive category corresponding to the text input 906. The multi-headed composite model 314 may be configured to generate, using the at least one model head, the output embedding 328 based on the intermediate output.

In some embodiments, the multi-headed composite model 314 includes a gate function 902 that is configured to select the at least one model head of the multi-headed composite model 314 based on the predictive category. By doing so, the gate function 902 may route different inputs of the multi-headed composite model 314 through different branches of the multi-headed composite model 314, each formed by the model body 312 and a respective one of the model heads 316a-c. The gate function 902, for example, may include a trained function that is configured to process an input data object to select a particular model head of the multi-headed composite model 314 for the input data object. For each input data object, the gate function 902 may be trained to dynamically choose a particular model head to drive the choice of a particular model head for processing the input data object.

By way of example, the text input 906 may be processed by a given number (m) of attention blocks (e.g., the model body 312) common to all inputs. The gate function 902 may then select a head of the multi-headed composite model 314 corresponding to an internal category (e.g., a predictive category) input by the user and/or otherwise ascertainable from the input data object. As one example, in a clinical prediction domain, if a user specifies that the text input 906 of in input data object is a condition, the gate function 902 may select a model head with transferred knowledge from a teacher model trained on condition entries and further fine-tuned on condition entries. The output of the last attention block of the model body 312 may be processed by the head selected by the gate function 902 to generate the output embedding 328.

In some embodiments, the multi-headed composite model 314 may include a plurality of model heads that are tailored to a particular category of input data objects. For example, the number and/or type of model heads 316a-c may be based on a prediction domain. In some examples, each model head may correspond to an ontology category for a prediction domain. As one example, for a clinical prediction domain, each model head may correspond to a first-party ontology category for a universal medical coding set. By way of example, the multi-headed composite model 314 may be configured to generate a predictive label 904 for a text input 906 from one of a plurality of third-party sources in order to map inconsistent third-party coding formats to a single, consistent set of concepts.

In some embodiments, the predictive label 904 is a data entity that describes a prediction for a text input 906 to the multi-headed composite model 314. The predictive label 904, for example, may identify a first-party label from a canonical coding set that corresponds to the text input 906. In some examples, the first-party label may be based on a distance between the output embedding and/or one or more first-party embeddings corresponding to the plurality of first-party labels of the first party.

In some embodiments, the predictive label 904 is one of a plurality first-party labels from a canonical coding set defined, maintained, and/or otherwise used by a first party to provide a standardized representation of a plurality of inconsistent third-party coding sets. In some examples, the plurality of first-party labels may be grouped into a plurality of predictive categories. The multi-headed composite model 314 may include a particular model head for each of the plurality of predictive categories. By way of example, in a clinical context, the plurality of predictive categories may include fifteen categories based on the semantic types of a plurality of first-party labels. In such a case, the multi-headed composite model may include fifteen model heads, one specifically tailored to each of the fifteen categories.

In some embodiments, a predictive label 904 for the text input 906 may be output based on the output embedding 328. The predictive label may be indicative of one of a plurality of first-party labels. In some examples, the predictive label 904 may be indicative of one of a plurality of predefined ontology agnostic predictive labels.

In some embodiments, the predictive label 904 is identified based on a plurality of label probabilities. For example, a plurality of label probabilities may be generated based on a comparison between the output embedding 328 and a plurality of label embeddings corresponding to a plurality of first-party labels (e.g., predefined ontology agnostic predictive labels in a clinical prediction domain, etc.). Each of the plurality of label probabilities may be indicative of a distance between the output embedding 328 and a respective label embedding. In some examples, the predictive label 904 may be identified based on the plurality of label probabilities. By way of example, the predictive label may include a first-party label with a highest label probability (e.g., a label probability that satisfies a threshold, etc.) and/or the lowest distance measure relative to a plurality of label probabilities and/or distance measures for the plurality of first-party labels.

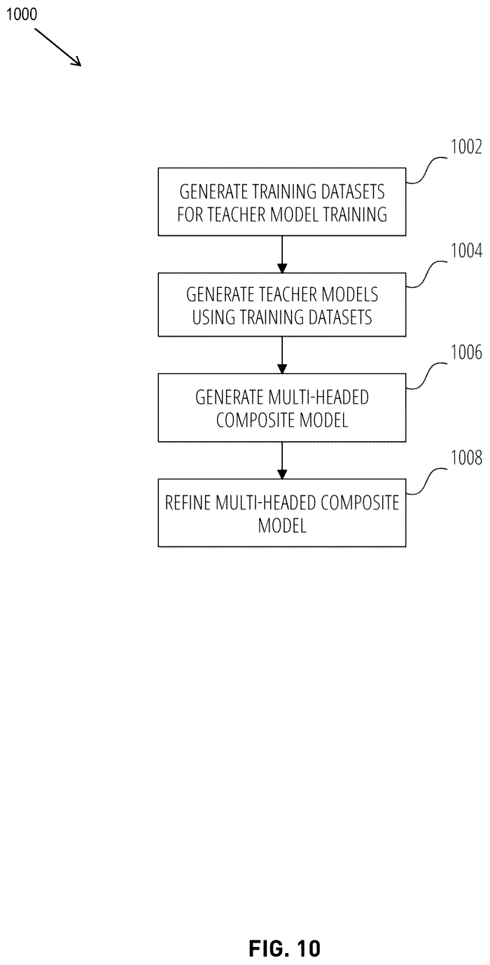

FIG. 10 is a flowchart showing an example of a process 1000 for generating a multi-headed composite model in accordance with some embodiments discussed herein. The flowchart depicts a multistage training technique for generating a multi-headed composite model to overcome various limitations of traditional predictive modeling and model training techniques. The multistage training techniques may be implemented by one or more computing devices, entities, and/or systems described herein. For example, via the various steps/operations of the process 1000, the computing system 100 may leverage the multistage training techniques to overcome the various limitations with traditional techniques by leveraging a plurality of training datasets and teacher models tailored to one or more aspects of a complex prediction domain to generate a multi-headed composite model capable of individually processing a wide variety of potential text inputs.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 includes, at step/operation 1002, generating training datasets for teacher model training. For example, the computing system 100 may generate a plurality of training datasets from a composite dataset. The plurality of training datasets may correspond to a plurality of predictive categories of a prediction domain. The plurality of training datasets may include a training dataset for each predictive category of the plurality of predictive categories. In some examples, the plurality of training datasets may be previously generated and the computing system 100 may receive the plurality of training datasets. For example, the plurality of training datasets may be previously generated based on a semantic similarity between a third-party category and a predictive category.

In some embodiments, a predictive category is indicative of an ontology category for a prediction domain. For example, a respective training dataset for the predictive category may include a plurality of mapped text sequences for the ontology category. In some examples, each of the plurality of mapped text sequences may include a text sequence and a training label corresponding to the text sequence.

In some embodiments, the process 1000 includes, at step/operation 1004, generating teacher models using the training datasets. For example, the computing system 100 may generate a plurality of teacher models that correspond to the plurality of predictive categories based on the plurality of training datasets. For instance, each teacher model may be trained by optimizing a triplet loss for a particular training dataset of the plurality of training datasets. In some examples, the plurality of teacher models may include a teacher model for each predictive category of the plurality of predictive categories.

In some embodiments, each of the plurality of teacher models is a deep neural network that includes a plurality of attention layers. The particular training dataset for a respective teacher model may include a plurality of text sequences and a plurality of training labels. The triplet loss may be based on (i) a first distance between an anchor text sequence and a positive training label and (ii) a second distance between the anchor text sequence and a negative training label. By way of example, the computing system 100 may generate, using a machine learning encoder model, a plurality of text embeddings for the plurality of text sequences and the plurality of training labels of the particular training dataset. The computing system 100 may generate the first distance based on a first cosine similarity distance between an anchor embedding corresponding to the anchor text sequence and a positive embedding corresponding to the positive training label. The computing system 100 may generate the second distance based on a second cosine similarity distance between the anchor embedding and a negative embedding corresponding to the negative training label. In some examples, the computing system 100 may optimize the triplet loss by minimizing the first distance and maximizing the second distance.

In some embodiments, the process 1000 includes, at step/operation 1006, generating a multi-headed composite model. For example, the computing system 100 may generate the multi-headed composite model based on a plurality of trained parameters for each of the plurality of teacher models. For instance, the multi-headed composite model may include a plurality of model heads that correspond to the plurality of teacher models.

In some embodiments, the multi-headed composite model includes a model body and a plurality of model heads. The computing system 100 may identify a first teacher model from the plurality of teacher models based on the plurality of training datasets. The first teacher model may be identified based on a number of mapped text sequences in a training dataset that corresponds to the first teacher model. The computing system 100 may generate the model body based on the plurality of trained parameters for the first teacher model. In addition, or alternatively, the computing system 100 may iteratively generate each model head of the plurality of model heads based on the plurality of trained parameters for each of the plurality of teacher models. For example, a model head may be generated based on the plurality of trained parameters for a respective teacher model of the plurality of teacher models.

In some embodiments, the process 1000 includes, at step/operation 1008, refining the multi-headed composite model. For example, the computing system 100 may refine the multi-headed composite model. To do so, the computing system 100 may generate, using the respective teacher model, a first output embedding for a mapped text sequence of a training dataset. The computing system 100 may generate, using the multi-headed composite model, a second output embedding for the mapped text sequence. And, the computing system 100 may update one or more parameters of the multi-headed composite model based on a comparison between the first output embedding and the second output embedding.

In this manner, a plurality of teacher models may be leveraged to train one universally applicable machine learning model. By leveraging the teacher training techniques, the multistage training techniques of the process 1000 may be practically applied to reduce training times and costs for generating a multi-headed model specially configured for robust prediction domains with a variety of predictive categories. The multi-headed composite model provides improved performance, and reduced costs and latencies relative to traditional machine learning techniques.

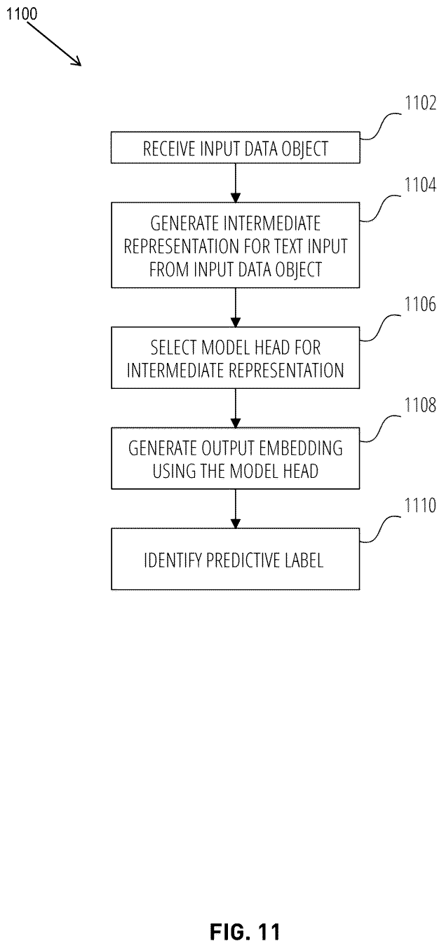

FIG. 11 is a flowchart showing an example of a process 1100 for generating a predictive label for a text input in accordance with some embodiments discussed herein. The flowchart depicts a multistage data processing technique for generating and using an output embedding for an input data object to overcome various limitations of traditional machine learning techniques. The multistage data processing techniques may be implemented by one or more computing devices, entities, and/or systems described herein. For example, via the various steps/operations of the process 1100, the computing system 100 may leverage the multistage data processing techniques to overcome the various limitations with traditional techniques by applying a multi-headed composite model to generate an output embedding that is specifically tailored to a text input. The output embedding may be used to improve a plurality of downstream computing tasks, including predictive computing techniques for identifying predictive labels for an otherwise incompatible input data object.

FIG. 11 illustrates an example process 1100 for explanatory purposes. Although the example process 1100 depicts a particular sequence of steps/operations, the sequence may be altered without departing from the scope of the present disclosure. For example, some of the steps/operations depicted may be performed in parallel or in a different sequence that does not materially impact the function of the process 1100. In other examples, different components of an example device or system that implements the process 1100 may perform functions at substantially the same time or in a specific sequence.

In some embodiments, the process 1100 includes, at step/operation 1102, receiving an input data object. For example, the computing system 100 may receive the input data object. The input data object may include a text input and/or contextual data. For instance, the computing system may receive the text input and the contextual data. The contextual data may be indicative of a predictive category for the text input. For instance, the contextual data may be indicative of a third-party category for the text input and the predictive category may be based on the third-party category. By way of example, the predictive category may be based on a semantic mapping between a plurality of third-party categories and a plurality of predictive categories. In addition, or alternatively, the contextual data may be indicative of user input that identifies the predictive category.

In some embodiments, the process 1100 includes, at step/operation 1104, generating intermediate representation for the text input from the input data object. For example, the computing system 100 may generate the intermediate representation using a multi-headed composite model. The multi-headed composite model may include a model body, a plurality of model heads, and/or a gate function. For instance, the multi-headed composite model may include a neural network. The model body may include a first plurality of attention blocks of the neural network and each model head of the plurality of model heads may include a second plurality of attention blocks of the neural network. In some examples, the intermediate representation for the text inputs may be generated using the model body of the multi-headed composite model. For example, the computing system 100 may generate, using the model body, the intermediate output for the text input.

In some embodiments, the process 1100 includes, at step/operation 1106, selecting a model head for processing the intermediate representation. For example, the computing system 100 may select the model head for processing the intermediate representation. For example, each of the plurality of model heads of the multi-headed composite model may correspond to a particular predictive category of a plurality of predictive categories of a prediction domain. The multi-headed composite model may include a gate function that is configured to select at least one model head of the multi-headed composite model based on the predictive category for the text input.

In some embodiments, the process 1100 includes, at step/operation 1108, generate an output embedding using the model head. For example, the computing system 100 may generate, using the multi-headed composite model, the output embedding for the text input based on the predictive category. For example, the computing system 100 may generate, using the at least one model head, the output embedding based on the intermediate output. As described herein, the text input may be processed with at least one model head of the multi-headed composite model based on the predictive category. For instance, an intermediate representation for the text input may be processed by the model head selected in step/operation 1106.

In this manner, a multi-headed machine learning model may be leveraged to generate an output embedding that is universally interpretable across multiple, disparate, third-party coding sets. Unlike traditional machine learning techniques that are limited to a single attention head, the multi-headed machine learning model is configured with a separate head tailored to each category of a complex prediction domain. The multiple heads of the multi-headed machine learning model allow the model to make more accurate predictions for a given quantity of computing resources by allowing each head of the branched architecture to specialize in a particular type of input. In this way, the multi-headed composite model may be practically applied to any prediction domain to improve performance and reduce costs and latencies relative to traditional machine learning techniques.

In some embodiments, the process 1100 includes, at step/operation 1110, identifying a predictive label based on the output embedding. For example, the computing system 100 may identify the predictive label based on the output embedding. The computing system 100 may provide the predictive label for the text input based on the output embedding.

In some examples, the predictive label may be one of a plurality of predefined ontology agnostic predictive labels for a prediction domain. For example, the computing system 100 may generate a plurality of label probabilities based on a comparison between the output embedding and a plurality of label embeddings corresponding to the plurality of predefined ontology agnostic predictive labels. Each of the plurality of label probabilities may be indicative of a distance between the output embedding and a respective label embedding of the plurality of label embeddings. The computing system 100 may identify the predictive label based on the plurality of label probabilities.

Some techniques of the present disclosure enable the generation of action outputs that may be performed to initiate one or more predictive actions to achieve real-world effects. The machine learning techniques of the present disclosure may be used, applied, and/or otherwise leveraged to generate predictive representations, such as output embeddings, and/or predictions, such as predictive labels. These outputs may be leveraged to initiate the performance of various computing tasks that improve the performance of a computing system (e.g., a computer itself, etc.) with respect to various predictive actions performed by the computing system.

In some examples, the computing tasks may include predictive actions that may be based on a prediction domain. A prediction domain may include any environment in which computing systems may be applied to achieve real-word insights, such as predictions, and initiate the performance of computing tasks, such as predictive actions, to act on the real-world insights. These predictive actions may cause real-world changes, for example, by controlling a hardware component, providing targeted alerts, automatically allocating computing or human resources, and/or the like.

Examples of prediction domains may include financial systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated server load balancing actions, automated computing resource allocation actions, automated adjustments to computing and/or human resource management, and/or the like.

As one example, a prediction domain may include a clinical prediction domain. In such a case, the predictive actions may include automated physician notification actions, automated patient notification actions, automated appointment scheduling actions, automated prescription recommendation actions, automated drug prescription generation actions, automated implementation of precautionary actions, automated record updating actions, automated datastore updating actions, automated hospital preparation actions, automated workforce management operational management actions, automated server load balancing actions, automated resource allocation actions, automated call center preparation actions, automated hospital preparation actions, automated pricing actions, automated plan update actions, automated alert generation actions, and/or the like.

In some embodiments, the multistage data processing techniques of process 1100 are applied to initiate the performance of one or more predictive actions. As described herein, the predictive actions may depend on the prediction domain. In some examples, the computing system 100 may leverage the multistage data processing techniques to generate an output embedding and/or a predictive label. Using the output embedding and/or the predictive label, the computing system 100 may generate an action output that is personalized and tailored to an input data object at a particular moment in time. These predictive insights may be leveraged to initiate the performance of the one or more predictive actions within a respective prediction domain. By way of example, the prediction domain may include a clinical prediction domain and the one or more predictive actions may include performing a resource-based action (e.g., allocation of resource), generating a diagnostic report, generating action scripts, generating alerts or messages, generating one or more electronic communications, and/or the like. The one or more predictive actions may further include displaying visual renderings of the aforementioned examples of predictive actions in addition to values, charts, and representations associated with the third-party data sources and/or third-party datasets thereof.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method, the computer-implemented method comprising receiving, by one or more processors, a plurality of training datasets corresponding to a plurality of predictive categories; generating, by the one or more processors, a plurality of teacher models corresponding to the plurality of predictive categories based on the plurality of training datasets, wherein each teacher model is trained by optimizing a triplet loss for a particular training dataset of the plurality of training datasets; and generating, by the one or more processors, a multi-headed composite model based on a respective plurality of trained parameters for each of the plurality of teacher models, wherein the multi-headed composite model comprises a plurality of model heads that correspond to the plurality of teacher models.

Example 2. The computer-implemented method of example 1, wherein the plurality of training datasets comprise a respective training dataset for each predictive category of the plurality of predictive categories, and the plurality of teacher models comprise a respective teacher model for each predictive category of the plurality of predictive categories.

Example 3. The computer-implemented method of example 2, wherein a predictive category is indicative of an ontology category for a prediction domain, and wherein a training dataset for the predictive category comprises a plurality of mapped text sequences for the ontology category.

Example 4. The computer-implemented method of example 3, wherein each of the plurality of mapped text sequences comprises a text sequence and a training label corresponding to the text sequence.

Example 5. The computer-implemented method of any of the preceding examples, wherein the plurality of training datasets are previously generated based on a semantic similarity between a third-party category and a predictive category.

Example 6. The computer-implemented method of any of the preceding examples, wherein each of the plurality of teacher models is a deep neural network comprising a plurality of attention layers.

Example 7. The computer-implemented method of any of the preceding examples, wherein the particular training dataset for a teacher model of the plurality of teacher models comprises a plurality of text sequences and a plurality of training labels, and the triplet loss is based on (i) a first distance between an anchor text sequence of the plurality of text sequences and a positive training label and (ii) a second distance between the anchor text sequence and a negative training label.

Example 8. The computer-implemented method of example 7, wherein optimizing the triplet loss comprises minimizing the first distance and maximizing the second distance.

Example 9. The computer-implemented method of example 7 or 8 further comprising generating, using a machine learning encoder model, a plurality of text embeddings for the plurality of text sequences and the plurality of training labels; generating the first distance based on a first cosine similarity distance between an anchor embedding corresponding to the anchor text sequence and a positive embedding corresponding to the positive training label; and generating the second distance based on a second cosine similarity distance between the anchor embedding and a negative embedding corresponding to the negative training label.

Example 10. The computer-implemented method of any of the preceding examples, wherein the multi-headed composite model comprises a model body and the plurality of model heads, and wherein generating the multi-headed composite model comprises identifying a teacher model from the plurality of teacher models based on the plurality of training datasets, wherein the teacher model is identified based on a number of mapped text sequences in a training dataset that corresponds to the teacher model; and generating the model body based on a plurality of trained parameters for the teacher model.

Example 11. The computer-implemented method of example 10 further comprising generating a model head of the plurality of model heads based on the plurality of trained parameters for the teacher model.

Example 12. The computer-implemented method of example 11, wherein generating the model head of the multi-headed composite model comprises generating, using the teacher model, a first output embedding for a mapped text sequence of the training dataset; generating, using the multi-headed composite model, a second output embedding for the mapped text sequence; and updating one or more parameters of the multi-headed composite model based on a comparison between the first output embedding and the second output embedding.

Example 13. A computing apparatus comprising memory and one or more processors communicatively coupled to the memory, the one or more processors configured to receive a plurality of training datasets corresponding to a plurality of predictive categories; generate a plurality of teacher models corresponding to the plurality of predictive categories based on the plurality of training datasets, wherein each teacher model is trained by optimizing a triplet loss for a particular training dataset of the plurality of training datasets; and generate a multi-headed composite model based on a plurality of trained parameters for each of the plurality of teacher models, wherein the multi-headed composite model comprises a plurality of model heads that correspond to the plurality of teacher models.

Example 14. The computing apparatus of example 13, wherein the plurality of training datasets comprise a respective training dataset for each predictive category of the plurality of predictive categories, and the plurality of teacher models comprise a respective teacher model for each predictive category of the plurality of predictive categories.

Example 15. The computing apparatus of example 14, wherein a predictive category is indicative of an ontology category for a prediction domain, and wherein a training dataset for the predictive category comprises a plurality of mapped text sequences for the ontology category.

Example 16. The computing apparatus of example 15, wherein each of the plurality of mapped text sequences comprises a text sequence and a training label corresponding to the text sequence.

Example 17. The computing apparatus of any of examples 13 through 16, wherein the plurality of training datasets are previously generated based on a semantic similarity between a third-party category and a predictive category.

Example 18. The computing apparatus of any of examples 13 through 16, wherein each of the plurality of teacher models is a deep neural network comprising a plurality of attention layers.

Example 19. One or more non-transitory computer-readable storage media including instructions that, when executed by one or more processors, cause the one or more processors to receive a plurality of training datasets corresponding to a plurality of predictive categories; generate a plurality of teacher models corresponding to the plurality of predictive categories based on the plurality of training datasets, wherein each teacher model is trained by optimizing a triplet loss for a particular training dataset of the plurality of training datasets; and generate a multi-headed composite model based on a plurality of trained parameters for each of the plurality of teacher models, wherein the multi-headed composite model comprises a plurality of model heads that correspond to the plurality of teacher models.

Example 20. The one or more non-transitory computer-readable storage media of example 19, wherein the particular training dataset for a teacher model of the plurality of teacher models comprises a plurality of text sequences and a plurality of training labels, and the triplet loss is based on (i) a first distance between an anchor text sequence of the plurality of text sequences and a positive training label and (ii) a second distance between the anchor text sequence and a negative training label.

Example 21. A computer-implemented method, the computer-implemented method comprising receiving, by one or more processors, a text input and contextual data indicative of a predictive category for the text input; generating, by the one or more processors and using a multi-headed composite model, an output embedding for the text input based on the predictive category, wherein the multi-headed composite model comprises a model body, a plurality of model heads, and a gate function, the text input is processed with at least one model head of the plurality of model heads, and the gate function is configured to select the at least one model head based on the predictive category for the text input; and providing, by the one or more processors, a predictive label for the text input based on the output embedding.

Example 22. The computer-implemented method of example 21, wherein the contextual data is indicative of a third-party category for the text input and the predictive category is based on the third-party category.

Example 23. The computer-implemented method of example 22, wherein the predictive category is based on a semantic mapping between a plurality of third-party categories and a plurality of predictive categories.

Example 24. The computer-implemented method of any of examples 21 through 23, wherein the contextual data is indicative of user input that identifies the predictive category.

Example 25. The computer-implemented method of any of examples 21 through 24, wherein the multi-headed composite model comprises a neural network.

Example 26. The computer-implemented method of example 25, wherein the model body comprises a first plurality of attention blocks of the neural network and each model head of the plurality of model heads comprises a second plurality of attention blocks of the neural network.

Example 27. The computer-implemented method of example 26, wherein each of the plurality of model heads corresponds to a particular predictive category of a plurality of predictive categories in a prediction domain.

Example 28. The computer-implemented method of any of examples 21 through 27, wherein generating the output embedding comprises generating, using the model body, an intermediate output for the text input; and generating, using the at least one model head, the output embedding based on the intermediate output.

Example 29. The computer-implemented method of any of examples 21 through 28, wherein the predictive label is one of a plurality of predefined ontology agnostic predictive labels.

Example 30. The computer-implemented method of example 29, wherein providing the predictive label for the text input based on the output embedding comprises generating a plurality of label probabilities based on a comparison between the output embedding and a plurality of label embeddings corresponding to the plurality of predefined ontology agnostic predictive labels; and identifying the predictive label based on the plurality of label probabilities.

Example 31. The computer-implemented method of example 30, wherein each of the plurality of label probabilities are indicative of a distance between the output embedding and a respective label embedding of the plurality of label embeddings.

Example 32. A computing apparatus comprising memory and one or more processors communicatively coupled to the memory, the one or more processors configured to receive a text input and contextual data indicative of a predictive category for the text input; generate, using a multi-headed composite model, an output embedding for the text input based on the predictive category, wherein the multi-headed composite model comprises a model body, a plurality of model heads, and a gate function, the text input is processed with at least one model head of the plurality of model heads, and the gate function is configured to select the at least one model head based on the predictive category for the text input; and provide a predictive label for the text input based on the output embedding.

Example 33. The computing apparatus of example 32, wherein the contextual data is indicative of a third-party category for the text input and the predictive category is based on the third-party category.

Example 34. The computing apparatus of example 33, wherein the predictive category is based on a semantic mapping between a plurality of third-party categories and a plurality of predictive categories.

Example 35. The computing apparatus of any of examples 32 through 34, wherein the contextual data is indicative of user input that identifies the predictive category.

Example 36. The computing apparatus of any of examples 32 through 35, wherein the multi-headed composite model comprises a neural network.

Example 37. The computing apparatus of example 36, wherein the model body comprises a first plurality of attention blocks of the neural network and each model head of the plurality of model heads comprises a second plurality of attention blocks of the neural network.

Example 38. One or more non-transitory computer-readable storage media including instructions that, when executed by one or more processors, cause the one or more processors to receive a text input and contextual data indicative of a predictive category for the text input; generate, using a multi-headed composite model, an output embedding for the text input based on the predictive category, wherein the multi-headed composite model comprises a model body, a plurality of model heads, and a gate function, the text input is processed with at least one model head of the plurality of model heads, and the gate function is configured to select the at least one model head based on the predictive category for the text input; and provide a predictive label for the text input based on the output embedding.

Example 39. The one or more non-transitory computer-readable storage media of example 38, wherein the multi-headed composite model comprises a neural network.

Example 40. The one or more non-transitory computer-readable storage media of examples 38 or 39, wherein the model body comprises a first plurality of attention blocks of the neural network and each model head of the plurality of model heads comprises a second plurality of attention blocks of the neural network.

1. A computer-implemented method, the computer-implemented method comprising:
receiving, by one or more processors, a text input and contextual data indicative of a predictive category for the text input;
generating, by the one or more processors and using a multi-headed composite model, an output embedding for the text input based on the predictive category, wherein:
the multi-headed composite model comprises a model body, a plurality of model heads, and a gate function,
the text input is processed with at least one model head of the plurality of model heads, and
the gate function is configured to select the at least one model head based on the predictive category for the text input; and
providing, by the one or more processors, a predictive label for the text input based on the output embedding.

2. The computer-implemented method of claim 1, wherein the contextual data is indicative of a third-party category for the text input and the predictive category is based on the third-party category.

3. The computer-implemented method of claim 2, wherein the predictive category is based on a semantic mapping between a plurality of third-party categories and a plurality of predictive categories.

4. The computer-implemented method of claim 1, wherein the contextual data is indicative of user input that identifies the predictive category.

5. The computer-implemented method of claim 1, wherein the multi-headed composite model comprises a neural network.

6. The computer-implemented method of claim 5, wherein the model body comprises a first plurality of attention blocks of the neural network and each model head of the plurality of model heads comprises a second plurality of attention blocks of the neural network.

7. The computer-implemented method of claim 6, wherein each of the plurality of model heads corresponds to a particular predictive category of a plurality of predictive categories in a prediction domain.

8. The computer-implemented method of claim 1, wherein generating the output embedding comprises:
generating, using the model body, an intermediate output for the text input; and
generating, using the at least one model head, the output embedding based on the intermediate output.

9. The computer-implemented method of claim 1, wherein the predictive label is one of a plurality of predefined ontology agnostic predictive labels.

10. The computer-implemented method of claim 9, wherein providing the predictive label for the text input based on the output embedding comprises:
generating a plurality of label probabilities based on a comparison between the output embedding and a plurality of label embeddings corresponding to the plurality of predefined ontology agnostic predictive labels; and
identifying the predictive label based on the plurality of label probabilities.

11. The computer-implemented method of claim 10, wherein each of the plurality of label probabilities are indicative of a distance between the output embedding and a respective label embedding of the plurality of label embeddings.

12. A system comprising memory and one or more processors communicatively coupled to the memory, the one or more processors configured to:
receive a text input and contextual data indicative of a predictive category for the text input;
generate, using a multi-headed composite model, an output embedding for the text input based on the predictive category, wherein:
the multi-headed composite model comprises a model body, a plurality of model heads, and a gate function,
the text input is processed with at least one model head of the plurality of model heads, and
the gate function is configured to select the at least one model head based on the predictive category for the text input; and
provide a predictive label for the text input based on the output embedding.

13. The system of claim 12, wherein the contextual data is indicative of a third-party category for the text input and the predictive category is based on the third-party category.

14. The system of claim 13, wherein the predictive category is based on a semantic mapping between a plurality of third-party categories and a plurality of predictive categories.

15. The system of claim 12, wherein the contextual data is indicative of user input that identifies the predictive category.

16. The system of claim 12, wherein the multi-headed composite model comprises a neural network.

17. The system of claim 16, wherein the model body comprises a first plurality of attention blocks of the neural network and each model head of the plurality of model heads comprises a second plurality of attention blocks of the neural network.

18. One or more non-transitory computer-readable storage media including instructions that, when executed by one or more processors, cause the one or more processors to:
receive a text input and contextual data indicative of a predictive category for the text input;
generate, using a multi-headed composite model, an output embedding for the text input based on the predictive category, wherein:
the multi-headed composite model comprises a model body, a plurality of model heads, and a gate function,
the text input is processed with at least one model head of the plurality of model heads, and
the gate function is configured to select the at least one model head based on the predictive category for the text input; and
provide a predictive label for the text input based on the output embedding.

19. The one or more non-transitory computer-readable storage media of claim 18, wherein the multi-headed composite model comprises a neural network.

20. The one or more non-transitory computer-readable storage media of claim 18, wherein the model body comprises a first plurality of attention blocks of the neural network and each model head of the plurality of model heads comprises a second plurality of attention blocks of the neural network.
